(19) United States
(12) Patent Application Publication
(10) Pub. No.: US 2024/0334320 A1
(43) Pub. Date: Oct. 3, 2024

(54) TECHNIQUES FOR SWITCHING BETWEEN NETWORK SLICES

(71) Applicant: QUALCOMM Incorporated, San Diego, CA (US)

(72) Inventors: Jianhua LIU, Beijing (CN); Miguel GRIOT, La Jolla, CA (US); Ozcan OZTURK, San Diego, CA (US); Peng CHENG, Beijing (CN); Gavin Bernard HORN, La Jolla, CA (US)

(21) Appl. No.: 18/694,833

(22) PCT Filed: Dec. 3, 2021
(86) PCT No.: PCT/CN2021/135343

§ 371 Date: Mar. 22, 2024

(51) Int. Cl. H04W 48/18; H04W 36/00; H04W 72/0453

(52) U.S. Cl. CPC H04W 48/18; H04W 36/13; H04W 72/0453

(57) ABSTRACT

Methods, systems, and devices for wireless communications are described. A user equipment (UE) may identify that the UE is in communication with a first slice of a network via a first control entity at the UE, and may determine that the UE is to further communicate with a second slice of the network. The UE may transmit a control message associated with the first control entity, where the control message may include a request pertaining to communications with the second slice. The UE may receive, in response to the control message and at the first control entity, a reconfiguration message indicating a configuration for using the second slice. The UE may communicate with the second slice of the network based on the configuration.

### CROSS REFERENCE

The present Application is a 371 national stage filing of International PCT Application No. PCT/CN2021/135343 by LIU et al. entitled “TECHNIQUES FOR SWITCHING BETWEEN NETWORK SLICES,” filed Dec. 3, 2021, which is assigned to the assignee hereof, and which is expressly incorporated by reference in its entirety herein.

### FIELD OF TECHNOLOGY

The following relates to wireless communications, including techniques for switching between network slices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may be able to access multiple slices of a network. In some cases, multiple slices of the network may be able to provide services to the UE concurrently, and in some other cases, some slices may be unable to provide concurrent services to the UE, such as due to the configuration of each slice. For example, a UE may be configured with access to a first network slice and a second network slice but the first and second network slices may be associated with configurations incompatible with one another. Techniques for allowing a UE to utilize different network slices may be improved.

### SUMMARY

The described techniques relate to improved methods, systems, devices, and apparatuses that support techniques for switching between network slices. Generally, the described techniques provide for improved methods for a user equipment (UE) to utilize multiple slices of a network. In some cases, the methods may allow for the UE to utilize multiple different slices concurrently based on configuration compatibility of the multiple slices. In some cases, the methods may allow a UE to efficiently suspend (e.g., or release) communication configurations of one slice upon arrival of communications with another slice. The methods described herein may allow for a UE to communicate using multiple slices of a network (e.g., concurrently, or at different times) without performing a radio resource control (RRC) connection establishment procedure each time the UE determines to communicate in accordance with a different network slice.

For example, a UE may identify that the UE is in communication with a first slice of a network via a first control entity at the UE, and the UE may determine that the UE is to further communicate with a second slice of the network (e.g., upon arrival of data associated with the second slice). The first slice may be served by a first core network and the second slice may be served by a second core network. The UE may transmit a control message (e.g., an RRC message), where the control message may include a request pertaining to communications with the second slice. In some cases, the UE may transmit the control message to a distributed unit (DU) that the UE is connected with. In such cases, the DU may relay the control message to a centralized unit (CU) or a radio access network (RAN). In some cases, the UE may transmit the control message directly to a RAN. The RAN (or CU) may select the second core network and may relay the control message to the second core network. The second core network may receive the control message and may communicate with the first core network, the RAN (or CU), or both to set up UE configuration for the second slice.

Accordingly, the UE may receive, in response to the control message, a reconfiguration message (e.g., an RRC reconfiguration message) indicating a configuration for using the second slice. The UE may communicate with the second slice of the network based on the configuration. In some cases, the UE may utilize a single access protocol entity (e.g., RRC entity) to utilize the multiple network slices. In some cases, the UE may utilize the multiple network slices in accordance with dual-registration.

A method for wireless communications at a user equipment (UE) is described. The method may include identifying that the UE is in communication with a first slice of a network via a first control entity at the UE, determining that the UE is to further communicate with a second slice of the network, transmitting a control message associated with the first control entity, the control message including a request pertaining to communications with the second slice, receiving, in response to the control message and at the first control entity, a reconfiguration message indicating a configuration for using the second slice, and communicating with the second slice of the network based on the configuration.

An apparatus for wireless communications is described. The apparatus may include a processor, memory coupled with the processor, and instructions stored in the memory. The instructions may be executable by the processor to cause the apparatus to identify that a UE is in communication with a first slice of a network via a first control entity at the UE, determine that the UE is to further communicate with a second slice of the network, transmit a control message associated with the first control entity, the control message including a request pertaining to communications with the second slice, receive, in response to the control message and at the first control entity, a reconfiguration message indicating a configuration for using the second slice, and communicate with the second slice of the network based on the configuration.

Another apparatus for wireless communications is described. The apparatus may include means for identifying that a UE is in communication with a first slice of a network via a first control entity at the UE, means for determining that the UE is to further communicate with a second slice of the network, means for transmitting a control message associated with the first control entity, the control message including a request pertaining to communications with the second slice, means for receiving, in response to the control message and at the first control entity, a reconfiguration message indicating a configuration for using the second slice, and means for communicating with the second slice of the network based on the configuration.

A non-transitory computer-readable medium storing code for wireless communications is described. The code may include instructions executable by a processor to identify that a UE is in communication with a first slice of a network via a first control entity at the UE, determine that the UE is to further communicate with a second slice of the network, transmit a control message associated with the first control entity, the control message including a request pertaining to communications with the second slice, receive, in response to the control message and at the first control entity, a reconfiguration message indicating a configuration for using the second slice, and communicate with the second slice of the network based on the configuration.

Some examples of the method, apparatuses, and non-transitory computer-readable medium described herein may further include operations, features, means, or instructions for identifying that the first slice may be associated with a first core network and the second slice may be supported by a second core network and determining whether the UE may be registered with the second core network based on determining that the UE may be to further communicate with the second slice.

In some examples of the method, apparatuses, and non-transitory computer-readable medium described herein, transmitting the control message may include operations, features, means, or instructions for transmitting a non-access stratum protocol data unit including information associated with the second slice based on determining that the UE may be registered with the second core network.

In some examples of the method, apparatuses, and non-transitory computer-readable medium described herein, transmitting the control message may include operations, features, means, or instructions for transmitting the non-access stratum protocol data unit including a service request to activate a protocol data unit session for the second slice.

In some examples of the method, apparatuses, and non-transitory computer-readable medium described herein, transmitting the control message may include operations, features, means, or instructions for determining whether there may be an existing protocol data unit session for the second slice and transmitting the non-access stratum protocol data unit including a protocol data unit session establishment request to establish a protocol data unit session based on the determination of whether there may be the existing protocol data unit session.

In some examples of the method, apparatuses, and non-transitory computer-readable medium described herein, transmitting the control message may include operations, features, means, or instructions for transmitting a non-access stratum protocol data unit including a register request to register with the second core network based on determining that the UE may be unregistered with the second core network and establishing a protocol data unit session with the second core network.

In some examples of the method, apparatuses, and non-transitory computer-readable medium described herein, determining whether the UE may be registered with the second core network may include operations, features, means, or instructions for identifying that the first core network may be associated with a first public land mobile network and the second core network may be associated with a second public land mobile network and determining whether the UE may be registered with the second public land mobile network.

Some examples of the method, apparatuses, and non-transitory computer-readable medium described herein may further include operations, features, means, or instructions for identifying a system information block including information associated with the second slice, where identifying that the second slice may be supported by the second core network may be based on the system information block.

Some examples of the method, apparatuses, and non-transitory computer-readable medium described herein may further include operations, features, means, or instructions for determining that the UE may be connected with a first distributed unit, the first distributed unit serving the first slice and a second distributed unit serving the second slice, where the UE transmits the control message to the first distributed unit and receives the reconfiguration message from the first distributed unit.

In some examples of the method, apparatuses, and non-transitory computer-readable medium described herein, determining that the UE may be to further communicate with the second slice may include operations, features, means, or instructions for determining an arrival of application data associated with the second slice and determining that the second slice may be unsupported by the first distributed and may be supported by the second distributed unit.

Some examples of the method, apparatuses, and non-transitory computer-readable medium described herein may further include operations, features, means, or instructions for determining that a radio link quality between the UE and the second distributed unit meets a threshold.

Some examples of the method, apparatuses, and non-transitory computer-readable medium described herein may further include operations, features, means, or instructions for transmitting a reconfiguration complete message to the second distributed unit in response to receiving the reconfiguration message.

Some examples of the method, apparatuses, and non-transitory computer-readable medium described herein may further include operations, features, means, or instructions for determining that the UE may be connected to a radio access network node, the radio access network node serving the first slice and the second slice, where the UE transmits the control message to the radio access network node and receives the reconfiguration message from the radio access network node.

In some examples of the method, apparatuses, and non-transitory computer-readable medium described herein, determining that the UE may be to further communicate with the second slice may include operations, features, means, or instructions for determining an arrival of application data associated with the second slice and determining that the second slice may be supported by the radio access network node.

Some examples of the method, apparatuses, and non-transitory computer-readable medium described herein may further include operations, features, means, or instructions for transmitting a reconfiguration complete message to the radio access network node in response to receiving the reconfiguration message.

In some examples of the method, apparatuses, and non-transitory computer-readable medium described herein, communicating with the second slice of the network may include operations, features, means, or instructions for communicating with the second slice and the first slice concurrently based on a configuration of the first slice and the configuration of the second slice supporting concurrent usage.

In some examples of the method, apparatuses, and non-transitory computer-readable medium described herein, receiving the reconfiguration message may include operations, features, means, or instructions for receiving the reconfiguration message including an indication to suspend configurations with the first slice based on a configuration of the first slice.

Some examples of the method, apparatuses, and non-transitory computer-readable medium described herein may further include operations, features, means, or instructions for receiving a second reconfiguration message including an indication for the UE to release configurations associated with the second slice and to resume communications with the first slice.

Some examples of the method, apparatuses, and non-transitory computer-readable medium described herein may further include operations, features, means, or instructions for releasing access stratum context and non-access stratum context associated with the second slice and resuming access stratum context and non-access stratum context associated with the first slice based on the second reconfiguration message.

In some examples of the method, apparatuses, and non-transitory computer-readable medium described herein, the first slice and the second slice may be supported by a single Packet Data Convergence Protocol unit or by separate Packet Data Convergence Protocol units.

In some examples of the method, apparatuses, and non-transitory computer-readable medium described herein, the first slice and the second slice may be supported by a single dedicated radio bearer or by separate dedicated radio bearers. The two slices identified by slice indication or core network indication.

Some examples of the method, apparatuses, and non-transitory computer-readable medium described herein may further include operations, features, means, or instructions for receiving an indication that the first slice may be associated with a first core network, a first non-access stratum, or both and that the second slice may be associated with a second core network, a second non-access stratum, or both based on the first slice and the second slice being supported by the single dedicated radio bearer.

In some examples of the method, apparatuses, and non-transitory computer-readable medium described herein, the first slice and the second slice may be supported by a single signaling radio bearer or by separate signaling radio bearers. The two NAS entities identified by NAS entity indication or slice indication.

In some examples of the method, apparatuses, and non-transitory computer-readable medium described herein, the first slice may be associated with a first non-access stratum and the second slice may be associated with a second non-access stratum and the first control entity may be a radio resource control entity that carries the first non-access stratum and the second non-access stratum.

In some examples of the method, apparatuses, and non-transitory computer-readable medium described herein, the first control entity may be a first radio resource control (RRC) entity, the control message may be an RRC message, and the reconfiguration message may be an RRC reconfiguration message.

A method for wireless communications at a UE is described. The method may include identifying that the UE is in communication with a first slice of a first network via a first control entity at the UE, determining that the UE is to further communicate with a second slice of a second network via a second control entity at the UE, verifying that the second slice is supported by the second network, and registering with the second network based on the second slice being supported by the second network.

An apparatus for wireless communications is described. The apparatus may include a processor, memory coupled with the processor, and instructions stored in the memory. The instructions may be executable by the processor to cause the apparatus to identify that a UE is in communication with a first slice of a first network via a first control entity at the UE, determine that the UE is to further communicate with a second slice of a second network via a second control entity at the UE, verify that the second slice is supported by the second network, and register with the second network based on the second slice being supported by the second network.

Another apparatus for wireless communications is described. The apparatus may include means for identifying that a UE is in communication with a first slice of a first network via a first control entity at the UE, means for determining that the UE is to further communicate with a second slice of a second network via a second control entity at the UE, means for verifying that the second slice is supported by the second network, and means for registering with the second network based on the second slice being supported by the second network.

A non-transitory computer-readable medium storing code for wireless communications is described. The code may include instructions executable by a processor to identify that a UE is in communication with a first slice of a first network via a first control entity at the UE, determine that the UE is to further communicate with a second slice of a second network via a second control entity at the UE, verify that the second slice is supported by the second network, and register with the second network based on the second slice being supported by the second network.

Some examples of the method, apparatuses, and non-transitory computer-readable medium described herein may further include operations, features, means, or instructions for receiving, via a system information block, supported slice information for the second network, where the verifying may be based on the supported slice information.

In some examples of the method, apparatuses, and non-transitory computer-readable medium described herein, the first network and the second network may be public land mobile networks (PLMNs).

A method for wireless communications at a wireless device is described. The method may include identifying that a UE is in communication with a first slice of a network, determining that the UE is to further communicate with a second slice of the network, receiving a control message associated with a first control entity, the control message including a request pertaining to communications with the second slice, and transmitting, in response to the control message and at the first control entity, a reconfiguration message indicating a configuration for using the second slice.

An apparatus for wireless communications is described. The apparatus may include a processor, memory coupled with the processor, and instructions stored in the memory. The instructions may be executable by the processor to cause the apparatus to identify that a UE is in communication with a first slice of a network, determine that the UE is to further communicate with a second slice of the network, receive a control message associated with a first control entity, the control message including a request pertaining to communications with the second slice, and transmit, in response to the control message and at the first control entity, a reconfiguration message indicating a configuration for using the second slice.

Another apparatus for wireless communications is described. The apparatus may include means for identifying that a UE is in communication with a first slice of a network, means for determining that the UE is to further communicate with a second slice of the network, means for receiving a control message associated with a first control entity, the control message including a request pertaining to communications with the second slice, and means for transmitting, in response to the control message and at the first control entity, a reconfiguration message indicating a configuration for using the second slice.

A non-transitory computer-readable medium storing code for wireless communications is described. The code may include instructions executable by a processor to identify that a UE is in communication with a first slice of a network, determine that the UE is to further communicate with a second slice of the network, receive a control message associated with a first control entity, the control message including a request pertaining to communications with the second slice, and transmit, in response to the control message and at the first control entity, a reconfiguration message indicating a configuration for using the second slice.

In some examples of the method, apparatuses, and non-transitory computer-readable medium described herein, the first slice may be supported by a first core network and the second slice may be supported by a second core network and the method, apparatuses, and non-transitory computer-readable medium may include further operations, features, means, or instructions for selecting the second core network based on the control message and relaying the control message to the second core network.

Some examples of the method, apparatuses, and non-transitory computer-readable medium described herein may further include operations, features, means, or instructions for receiving a UE context message and a non-access stratum protocol data unit associated with a second core network, where the non-access stratum protocol data unit includes a service accept message or a protocol data unit session establishment accept message based on the control message from the UE.

Some examples of the method, apparatuses, and non-transitory computer-readable medium described herein may further include operations, features, means, or instructions for establishing a signaling radio bearer for the non-access stratum protocol data unit associated with the second core network.

Some examples of the method, apparatuses, and non-transitory computer-readable medium described herein may further include operations, features, means, or instructions for determining a reconfiguration of an existing signaling radio bearer for the non-access stratum protocol data unit associated with the second core network.

Some examples of the method, apparatuses, and non-transitory computer-readable medium described herein may further include operations, features, means, or instructions for establishing a dedicated radio bearer for the non-access stratum protocol data unit associated with the second core network.

Some examples of the method, apparatuses, and non-transitory computer-readable medium described herein may further include operations, features, means, or instructions for determining to suspend configurations associated with the first slice based on a configuration of the first slice.

In some examples of the method, apparatuses, and non-transitory computer-readable medium described herein, transmitting the reconfiguration message may include operations, features, means, or instructions for transmitting the reconfiguration message including an indication to release configurations associated with the first slice.

Some examples of the method, apparatuses, and non-transitory computer-readable medium described herein may further include operations, features, means, or instructions for identifying an absence of data associated with the second slice while a release timer may be running and determining to resume communications with the first slice based on the absence of data.

Some examples of the method, apparatuses, and non-transitory computer-readable medium described herein may further include operations, features, means, or instructions for transmitting, to one or more other wireless devices, a UE context message including an indication to resume communications associated with the first slice and transmitting a second reconfiguration message indicating the UE to release context associated with the second slice and to resume context associated with the first slice.

In some examples of the method, apparatuses, and non-transitory computer-readable medium described herein, the wireless device includes a centralized unit and a distributed unit or includes a radio access network node.

In some examples of the method, apparatuses, and non-transitory computer-readable medium described herein, the first slice and the second slice may be supported by a single Packet Data Convergence Protocol unit or by separate Packet Data Convergence Protocol units.

In some examples of the method, apparatuses, and non-transitory computer-readable medium described herein, the first slice and the second slice may be supported by a single dedicated radio bearer or by separate dedicated radio bearers. The two slices identified by slice indication or core network indication.

Some examples of the method, apparatuses, and non-transitory computer-readable medium described herein may further include operations, features, means, or instructions for transmitting an indication that the first slice may be associated with a first core network, a first non-access stratum, or both and that the second slice may be associated with a second core network, a second non-access stratum, or both based on the first slice and the second slice being supported by the single dedicated radio bearer.

In some examples of the method, apparatuses, and non-transitory computer-readable medium described herein, the first slice and the second slice may be supported by a single signaling radio bearer or by separate signaling radio bearers. The two NAS entities identified by NAS entity indication or slice indication.

In some examples of the method, apparatuses, and non-transitory computer-readable medium described herein, the first control entity may be a first RRC entity, the control message may be an RRC message, and the reconfiguration message may be an RRC reconfiguration message.

### BRIEF DESCRIPTION OF THE DRAWINGS

FIG. 1 illustrates an example of a wireless communications system that supports techniques for switching between network slices in accordance with aspects of the present disclosure.

FIGS. 2A and 2B illustrate examples of wireless communications systems that support techniques for switching between network slices in accordance with aspects of the present disclosure.

FIGS. 3A, 3B, and 3C illustrate examples of functional layer architectures that support techniques for switching between network slices in accordance with aspects of the present disclosure.

FIGS. 4 through 7 illustrate examples of process flows that support techniques for switching between network slices in accordance with aspects of the present disclosure.

FIGS. 8 and 9 show block diagrams of devices that support techniques for switching between network slices in accordance with aspects of the present disclosure.

FIG. 10 shows a block diagram of a communications manager that supports techniques for switching between network slices in accordance with aspects of the present disclosure.

FIG. 11 shows a diagram of a system including a device that supports techniques for switching between network slices in accordance with aspects of the present disclosure.

FIGS. 12 and 13 show block diagrams of devices that support techniques for switching between network slices in accordance with aspects of the present disclosure.

FIG. 14 shows a block diagram of a communications manager that supports techniques for switching between network slices in accordance with aspects of the present disclosure.

FIG. 15 shows a diagram of a system including a device that supports techniques for switching between network slices in accordance with aspects of the present disclosure.

FIGS. 16 through 19 show flowcharts illustrating methods that support techniques for switching between network slices in accordance with aspects of the present disclosure.

### DETAILED DESCRIPTION

In some wireless communications systems, a user equipment (UE) may be configured with access to multiple network slices, where for each slice the UE may be given access to separate resources within a network that supports a particular service. In some cases, multiple slices of the network may be able to provide services to the UE concurrently, and in some other cases, some slices may be unable to provide concurrent services to the UE, such as due to the configuration of each slice. For example, a UE may be configured with access to a first network slice and a second network slice but the first and second network slices may be associated with configurations incompatible with one another.

To connect to a particular slice, a UE may maintain a radio resource control (RRC) connection with a slice. Accordingly, in the case that the UE is able to simultaneously connect with both slices, the UE may maintain two RRC entities and contexts, which may increase UE implementation complexity and signaling overhead. In the case that the UE is unable to simultaneously connect with both slices, the UE may have to switch RRC connections each time the UE switches slices, where to switch RRC connections, the UE may release the RRC connection with a first slice, enter into an idle state, and then initiate a new RRC connection associated with a second slice. Such procedures may increase overhead and UE power consumption.

To improve the slice usage by a UE, this techniques described herein allow for a UE to maintain a signal access stratum entity, such as a single RRC entity, that serves multiple slices. For example, the UE may maintain a single RRC entity that services multiple non-access stratum (NAS) entities, where each NAS entity is associated with a different network slice. In such cases, if the network slices allow for the UE to connect to both simultaneously, then the UE may maintain a single RRC connection, rather than multiple entities and contexts. In the case that the UE is unable to simultaneously connect with both slices, the UE may be able to efficiently switch between the two slices because the UE already has an RRC entity established that serves both slices. The approaches described herein may be based on network architecture, such as whether a centralized unit (CU) and multiple distributed units (DUs) are supporting the network slices or whether a radio access network (RAN) and a cell are supporting the multiple network slices.

Particular aspects of the subject matter described herein may be implemented to realize one or more advantages. The described techniques may support improvements in network slice utilization by a network device by decreasing signaling overhead, and decreasing latency among other advantages. As such, supported techniques may include improved network operations and, in some examples, may promote network efficiencies, among other benefits.

Aspects of the disclosure are initially described in the context of wireless communications systems. Aspects are then described with reference to functional layer architectures, and process flows. Aspects of the disclosure are further illustrated by and described with reference to apparatus diagrams, system diagrams, and flowcharts that relate to techniques for switching between network slices.

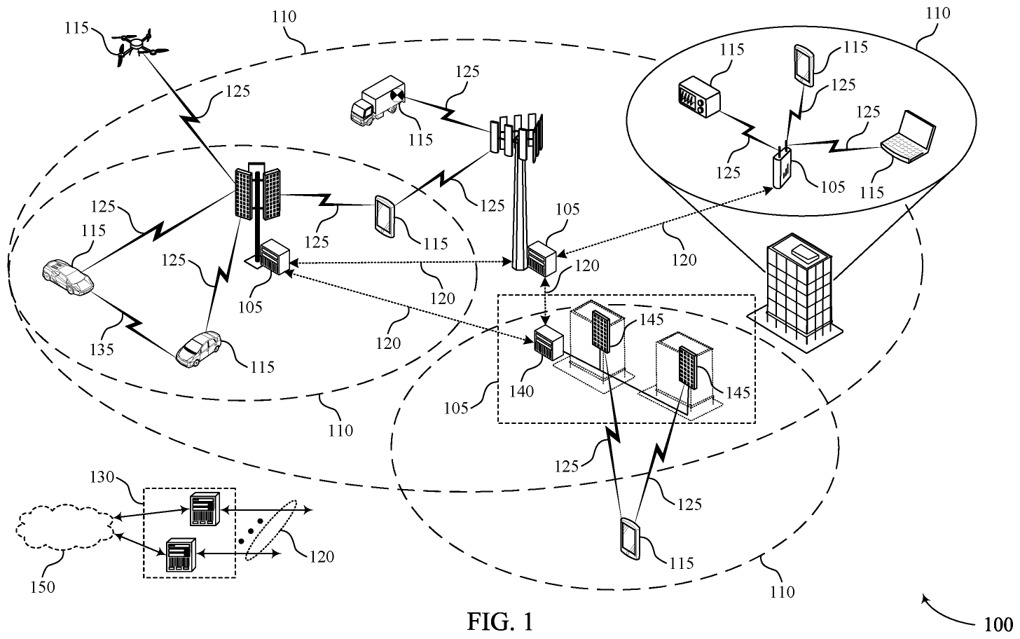

FIG. 1 illustrates an example of a wireless communications system 100 that supports techniques for switching between network slices in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1: M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage NAS functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

In some wireless communications systems, such as wireless communications system 100, a UE 115 may identify that the UE 115 is in communication with a first slice of a network via a first control entity at the UE 115, and the UE 115 may determine that the UE 115 is to further communicate with a second slice of the network (e.g., upon arrival of data associated with the second slice). The first slice may be served by a first core network and the second slice may be served by a second core network. The UE 115 may transmit a control message (e.g., an RRC message), where the control message may include a request pertaining to communications with the second slice. In some cases, the UE 115 may transmit the control message to a DU that the UE 115 is connected with. In such cases, the DU may relay the control message to a CU or a RAN (e.g., base station 105). In some cases, the UE 115 may transmit the control message directly to a RAN. The RAN (or CU) may select the second core network and may relay the control message to the second core network. The second core network may receive the control message and may communicate with the first core network, the RAN (or CU), or both to set up a UE 115 configuration for the second slice.

Accordingly, the UE 115 may receive, in response to the control message, a reconfiguration message (e.g., an RRC reconfiguration message) indicating a configuration for using the second slice. The UE 115 may communicate with the second slice of the network based on the configuration. In some cases, the UE 115 may utilize a single access protocol entity (e.g., RRC entity) to utilize the multiple network slices. In some cases, the UE 115 may utilize the multiple network slices in accordance with dual-registration.

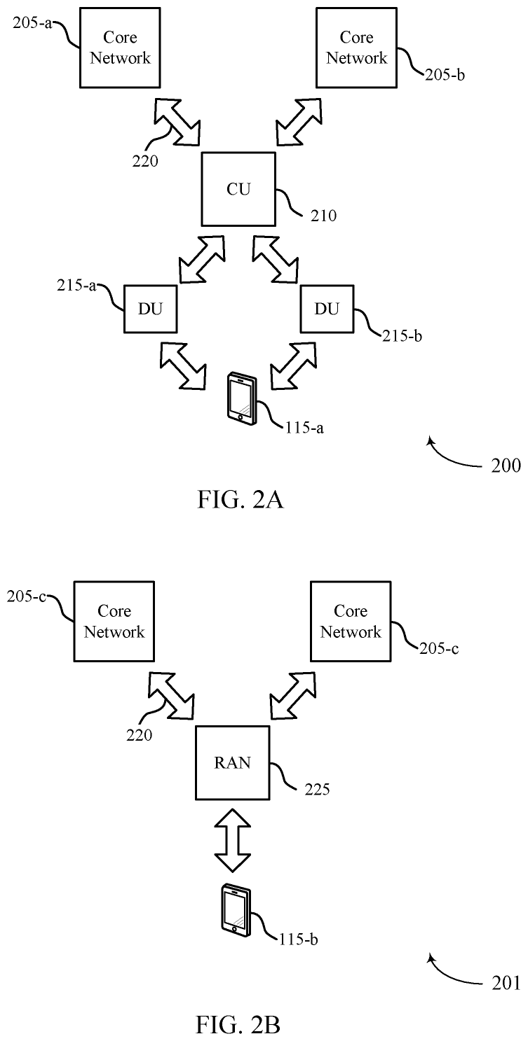

FIGS. 2A and 2B illustrate examples of wireless communications systems 200 and 201, respectively that support techniques for switching between network slices in accordance with aspects of the present disclosure. The wireless communications systems 200 and 201 may include network devices, such as a combination of DUs, CUS, RANs UEs, base stations, etc., which may be examples of the corresponding devices described with reference to FIG. 1. Wireless communications systems 200 and 201 may support an efficient procedure for supporting multiple network slices, for efficient slice-switching, or both by a network device, such as a UE 115.

In some wireless communications systems, a UE may be allowed access to multiple network slices. In some implementations, a UE 115 may access multiple network slices simultaneously, such as if the multiple network slices have compatible configurations to one another. In some other implementations, a UE 115 may not be able to access multiple network slices simultaneously. For example, multiple network slices may be associated with one or more related factors (e.g., enterprise use, personal use, isolation requirement, general public use vs public safety use, frequency limitation, location restriction, etc.). In some cases, multiple network slices may be deployed by a same or similar geographical location but the network slices may be incompatible by configuration.

For example, a network devices, such a RAN node 225, may connect two disjointed network slices, such as a first slice and a second slice, simultaneously. The first slice and the second slice may not have any shared (e.g., common) core network nodes supporting these network slices due to network resource incompatibility. For example, the first slice may be used for public security and the second slice may be used for Internet access. In some cases (e.g., in the 5G core network), dedicated network resources and network functionalities may be separately customized for public security emergency service and video service to meet the isolation requirements to ensure the independence of core network resources between different network slices. Accordingly, the first network slice and the second network slice may be isolated and cannot be simultaneously provided to a UE 115.

In some cases, a UE 115 authorized to access multiple network slices of one operator which cannot be simultaneously used by the UE 115 may be configured to access the most suitable network slice (e.g., based on the ongoing applications). In the case where a UE 115 is authorized to access multiple network slices of one operator which cannot be simultaneously used by the UE 115, the network may implement procedures that support minimized interruption when the UE 115 changes access from one network slice to another network slice (e.g., when triggered by changes of active applications). In some cases, a UE 115 may be configured to support a single access stratum entity, such as an RRC entity) that may serve multiple network slices to support the techniques described herein. In some cases, a UE 115 may be configured to perform the techniques described herein in accordance with dual-registration.

FIG. 2A may depict wireless communications system 200 that may support the techniques described herein for efficient network slice utilization (e.g., simultaneous utilization, efficient switching between network slices). With reference to FIG. 2A, a UE 115 such as UE 115-a may communicate with one or more core networks 205 via a split architecture. A network node may be split into multiple physical entities, such as a CU 210 and one or more DUs 215, such as DUs 215-a and 215-b. The split architecture may refer to a functional split in which the CU 210 may provide support for higher protocol stack layers such as SDAP, PDCP, and RRC, while a DU 215 may provide support for lower layers of the protocol stack such as RLC, MAC, and the physical layer.

In some implementations, each network slice may be supported by a different core network 205. For example, core network 205-a may be dedicated for a first network slice and core network 205-b may be dedicated for a second network slice. In accordance with a split architecture, a single CU 210 may be connected with both core network 205-a and core network 205-b. Each slice may then be supported by a different DU. For example, DU 215-a may service the first network slice via core network 205-a (e.g., at a first frequency) and DU 215-b may service the second network slice via core network 205-b (e.g., at a second frequency). Accordingly, UE 115-a may receive access to the first network slice from DU 215-a via communication link 220 (e.g., an uplink communications link, a downlink communications link), and may receive access to the second network slice from DU 215-b via a communications link 220.

FIG. 2B may depict wireless communications system 201 that may support the techniques described herein for efficient network slice utilization (e.g., simultaneous utilization, efficient switching between network slices). With reference to FIG. 2B, a UE 115 such as UE 115-b may communicate with one or more core networks 205 via a RAN 225. In some implementations, each network slice may be supported by a different core network 205. For example, core network 205-c may be dedicated for a first network slice and core network 205-d may be dedicated for a second network slice. The RAN 225 may be connected with both core network 205-c and core network 205-d. As the RAN 225 may be connected to both core networks 205, the RAN may support the first network slice and the second network slice. In some cases, a single cell may support both network slices. Accordingly, UE 115-b may receive access to the first network slice and the second network slice from RAN 225 via communication link 220 (e.g., an uplink communications link, a downlink communications link).

Accordingly, when a UE 115 is authorized to access multiple network slices of one operator, the UE 115 may use two slices simultaneously, and the UE 115 may connect to both core networks 205, simultaneously. In some implementations, for one UE 115, only one core network node may be selected to serve the UE 115. A UE RRC state and connection management (CM) state may be matched (e.g., when a NAS CM state is in an idle state, the UE RRC state is in an idle state), where the UE 115 may have to maintain multiple RRC entities and contexts to support multiple slices. Accordingly, to release the connection with a core network 205 for a first slice, the UE 115 may enter an idle state, then initiate a new RRC connection setup procedure to establish connection with a second core network 205 for the second slice. Such a procedure for switching between the two slices may result in significant RRC signaling overhead and UE power consumption. The techniques described herein provide solutions for the UE 115 to switch access from one network slice to another network slice, while minimizing service interruption during slice switching.

The network architectures described with reference to FIGS. 2A and 2B may be described as supporting two network slices but it should be understood that the techniques described herein are not limited to two network slices, and may be implemented to support any number of network slices.

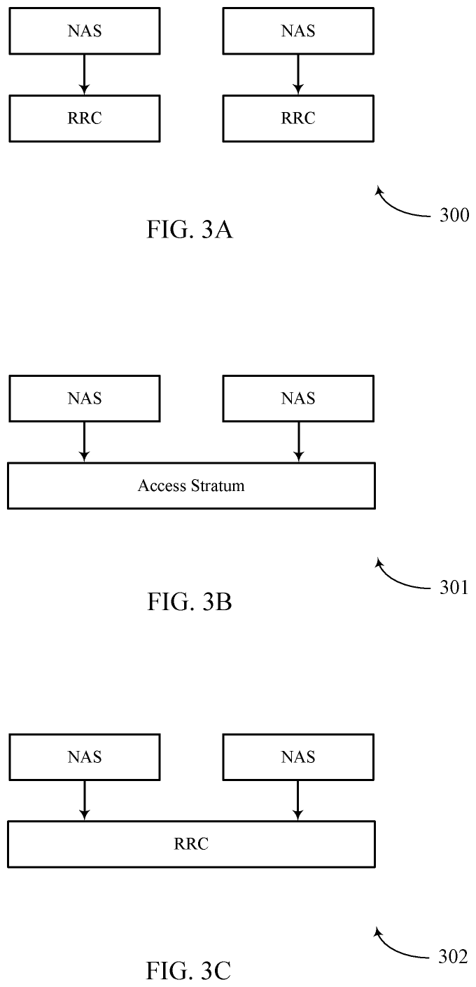

FIGS. 3A, 3B, and 3C illustrate examples of functional layer architectures 300, 301, and 302, respectively that support techniques for switching between network slices in accordance with aspects of the present disclosure. The functional layer architectures 300, 301, and 302 may be implemented by network devices, such as a combination of DUs, CUs, RANs UEs, base stations, etc., which may be examples of the corresponding devices described with reference to FIGS. 1 through 2B. Functional layer architectures 300, 301, and 302 may support an efficient procedure for supporting multiple network slices, for efficient slice-switching, or both by a network device, such as a UE 115.

A non-access stratum (NAS) layer is a functional layer in the protocol stacks between a core network and a UE. The NAS is used to manage the establishment of communication sessions and for maintaining continuous communications with the UE as the UE moves, or conditions change. The NAS layer may include at least a connection management (CM) layer. Accordingly, a UE may establish a NAS layer for each core network (e.g., each network slice) the UE has access to. An access stratum is a functional layer in the protocol stacks between a radio network (e.g., RAN, base station network node) and a UE. The access stratum layer may include an RRC layer, a PDCP layer, an RLC layer, a MAC layer, and a physical (PHY) layer. In some implementations, the CM state and the RRC state are matched, such that when the NAS CM state is in idle, the UE RRC state is in idle, for example. Accordingly, a UE may maintain an RRC entity for each network slice the UE has access to, as depicted with reference to FIG. 3A. For example, in the case of two network slices, the UE may use a first NAS and a first RRC layer to access a first network slice, and may use a second NAS and a second RRC layer to access a second network slice. In some cases, the UE may maintain the NAS and RRC layers for each slice at different times. For example, to gain access to the second slice, the UE may drop at least the RRC connection with the first network slice.

In some cases, the UE may maintain the NAS and RRC connection for multiple slices concurrently. For example, in the case of dual-registration, different network slices may be supported in two independent connectivities. Accordingly, in the case of two network slices, the network may treat the UE as two different UEs, one for each slice. As such, for each network slice, one RRC/NAS connection is established. In some cases, the UE may utilize the dual-registration mechanism to concurrently utilize multiple network slices (e.g., if the configurations of the multiple network slices allow), or may use the dual-registration mechanism to efficiently switch between network slices (e.g., in the case that the configurations of the network slices are incompatible).

In some implementations, a UE may be configured to maintain a single access entity to serve multiple NAS entities (e.g., to serve multiple network slices). For example, as depicted with reference to FIG. 3B, a UE may maintain a single access stratum layer to serve multiple NAS layers. As the access stratum layer may include multiple protocol stack layers, the UE may maintain a signal layer for each of the protocol stack layers to serve multiple NAS entities. For example, the UE may maintain a single RRC layer, a single RLC layer, a single PDCP layer, a single MAC layer, and a single PHY layer to serve the two different NAS entities.

In some cases, the UE may maintain a single entity for one or more access stratum layers and multiple entities for one or more other access stratum layers to serve multiple network slices. For example, as depicted with reference to FIG. 3C, the UE may maintain a single RRC entity to serve two different NAS entities. In some cases, the UE may maintain one or more PDCP entities, one or more RLC entities, one or more MAC entities, and one or more PHY entities to serve the multiple network entities. For example, the UE may maintain a single RRC entity, two PDCP entities, two RLC entities, two MAC entities, and two PHY entities to serve two NAS entities. In another example, the UE may maintain a single RRC entity and a single PDCP entity to serve multiple NAS entities, and maintain an RLC entity, MAC entity, and PHY entity for each NAS entity. Accordingly, the UE RRC state may be decoupled from the NAS CM state.

In some cases, multiple NAS entities may be carried in different or same signaling radio bearers (SRBs). For example, two NAS entities may be carried via two different SRBs or via a single SRB, where the two different NAS entities may be identified in the separate or single SRB via a NAS entity indication or slice indication. In some implementations, different NAS entities may be differentiated using different bearers or by an explicit indication.

By maintaining a single access stratum entity, such as a single RRC entity to serve multiple network slices, UE implementation complexity may be reduced because the UE may maintain one access stratum entity for multiple NAS entities, rather than maintaining one access stratum for each NAS entity. Additionally, a UE may concurrently utilize multiple network slices (e.g., if the configurations of the multiple network slices allow), or may use the single access stratum entity to efficiently switch between network slices (e.g., in the case that the configurations of the network slices are incompatible), as the UE may not have to re-establish an access stratum entity (e.g., an RRC connection) each time the UE determines to switch network slices.

The configurations described with reference to FIGS. 3A through 3C may be deployed to support communications in accordance with wireless communications system 200 as described with reference to FIG. 2A, or wireless communications system 201 as described with reference to FIG. 2B.

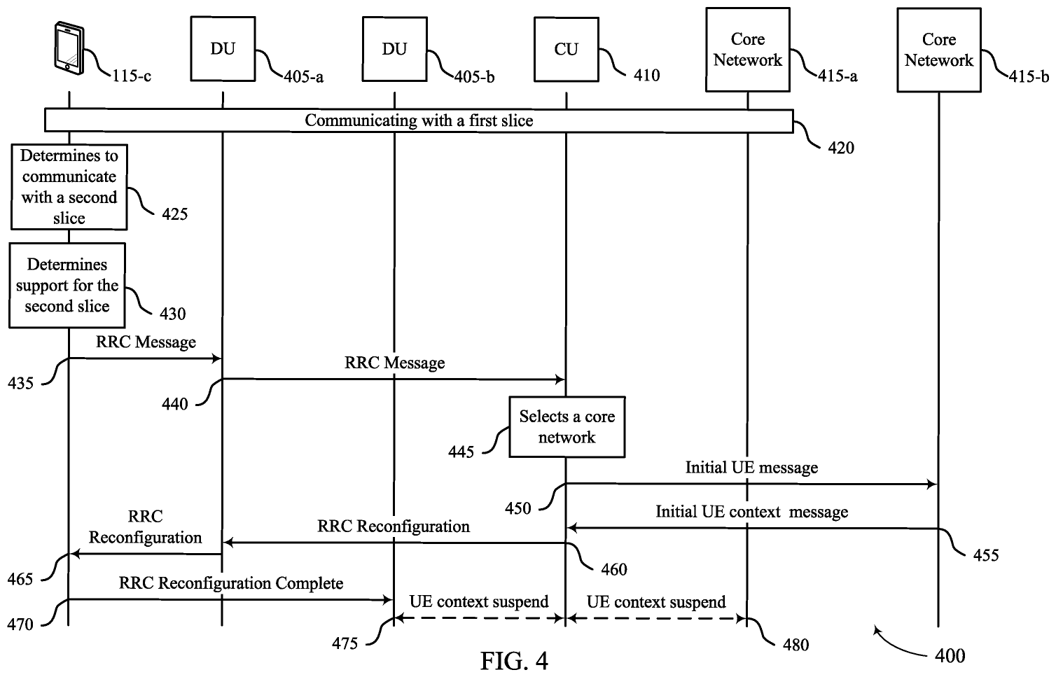

FIG. 4 illustrates an example of a process flow 400 that supports techniques for switching between network slices in accordance with aspects of the present disclosure. The process flow 400 may illustrate an example network slice switching procedure. For example, UE 115-c may determine to switch from using a first network slice to a second network slice. UE 115-c may perform such a slice switching procedure in the context of a split architecture including DUs 405-a and 405-b, CU 410, and core networks 415-a and 415-b, which may be examples of the corresponding wireless devices described with reference to FIGS. 1 through 3C. In some cases, instead of UE 115-c implementing the slice switching procedure, a different type of wireless device (e.g., a base station, DU 405, or some other network device) may perform a same or similar procedure. Alternative examples of the following may be implemented, where some steps are performed in a different order than described or are not performed at all. In some cases, steps may include additional features not mentioned below, or further steps may be added.

In some implementations, core network 415-a may serve a first network slice and core network 415-b may serve a second network slice. DU 405-a may be associated with core network 415-a (e.g., the first network slice) and DU 405-b may be associated with core network 415-b (e.g., the second network slice). CU 410 may support DU 405-a and DU 405-b, and may be connected with core network 415-a and core network 415-b. Each network slice may be supported by a different NAS entity, such that different NAS procedures may be associated with each slice. In some cases, UE 115-c may be configured with a single access stratum entity, such as a single RRC entity, to serve multiple NAS entities.

At 420, UE 115-c may be communicating (e.g., transmitting, receiving, or both) in accordance with the first network slice. For example, UE 115-c may be authorized with (at least) a first slice and a second slice and UE 115-c may already have established communications with core network 415-a for the first slice over DU 405-a (e.g., a first cell).

At 425, UE 115-c may determine to communicate in accordance with a second slice. For example, one or more messages (e.g., application data) may arrive for the second slice. At 430, UE 115-c may determine support for the second slice. For example, UE 115-c may determine whether the second slice is supported by DU 405-a. UE 115-a may determine that the second slice is not supported by the DU 405-a and may identify another DU 405 that supports the second slice. For example, UE 115-c may determine that DU 405-b supports the second slice. Additionally, UE 115-c may determine DU 405-b provides coverage to UE 115-c and/or whether the quality of coverage meets a threshold. For example, UE 115-c may measure one or more parameters associated with DU 405-a, such as one or more parameters associated with radio link quality. UE 115-c may compare the one or more parameters to a threshold, such as a radio link quality threshold.

At 435, UE 115-c may transmit an RRC message to DU 405-a, where the RRC message may include a NAS protocol data unit (PDU) indicating slice information for the second network slice. UE 115-c may intend for the RRC message (e.g., the RRC NAD PDU) to reach the CU 410 via DU 405-a.

In some cases, the NAS PDU may include a service request. For example, if UE 115-c has already registered with core network 415-b, and has established a PDU session for the second slice. Accordingly, UE 115-c may transmit the NAS PDU as a service request to activate the PDU session for the second slice. In some cases, the NAS PDU may include a PDU session establishment request. For example, if UE 115-c is registered with core network 415-b, but does not have an existing PDU session for the second slice, then UE 115-c may configure the NAS PDU as a PDU session establishment request. Accordingly, UE 115-c may transmit the PDU session establishment to establish PDU Session for the second slice. In some cases, the NAS PDU may include a register request. For example, if UE 115-c has not yet registered with core network 415-b, then UE 115-c may register with core network 415-b and then establish PDU session for the second slice via the NAS PDU message. The information associated with the second slice may be indicated per public land mobile network (PLMN), where a PLMN may refer to a CU/DU (or RAN) in combination with a core network 415. UE 115-c may identify whether UE 115-c has established a registration with or whether UE 115-c should register with the PLMN based on the second slice being indicated per PLMN.

At 440, DU 405-a may transmit (e.g., relay) the RRC message (e.g., the RRC NAS PDU) to the CU 410. At 445, the CU 410 may select a core network 415 based on the RRC message. The CU 410 may select core network 415-b based on the indicated slice information and/or PLMN information included in the RRC NAS PDU message.

At 450, the CU 410 may transmit an initial UE message to the selected core network 415-b. The CU 410 may forward the NAS PDU to core network 415-b.

At 455, core network 415-b may transmit an initial UE context message to the CU 410. Core network 415-b may identify the received NAS PDU (e.g., as today), and may transmit initial UE context with a NAS PDU to CU 410, core network 415-a, or both. The NAS PDU may be based on the NAS PDU at 435. For example, the NAS PDU may be a service accept message (e.g., in response to the Service Request) or a PDU session establishment accept (e.g., in response to the PDU session establishment request) based on the received NAS message from UE 115-c. If the NAS PDU received from UE 115-c includes a register request, then core network 415-b may transmit a transport message (e.g., downlink NAS transport) with the NAS PDU.

At 460, the CU 410 may transmit an RRC reconfiguration message to DU 405-a including the NAS PDU. The CU 410 may transmit the RRC reconfiguration message based on establishing the one or more radio bearers for core network 415-b.

At 465, DU 405-a may transmit (e.g., relay) the RRC reconfiguration message to UE 115-c. At 470, in response to the RRC reconfiguration message, UE 115-c may transmit an RRC reconfiguration complete message to DU 405-b.

The CU 410 may receive the UE context (e.g., initial UE context) from core network 415-b and may establish one or more radio bearers for core network 415-b. In some cases, the CU 410 may establish one SRB (e.g., a new SRB) to carry the NAS PDU for core network 415-b. The CU 410 may configure the SRB to UE 115-c. Accordingly, UE 115-c and the CU 410 may use different SRBs when transmitting NAS PDUs for core network 415-a versus core network 415-b. In some cases, the CU 410 may reconfigure an existing SRB (e.g., SRB2) to carry the NAS PDU for core network 415-b and may configure the SRB to UE 115-c. When UE 115-c and the CU 410 transmit a NAS PDU for core network 415-a and core network 415-b using the SRB (e.g., SRB2), UE 115-c and the CU 410 may indicate which NAS entity, which network slice, which core network 415, or a combination thereof the NAS PDU is associated with. In some cases, the CU 410 may configure a dedicated radio bearer (DRB) for the PDU session from core network 415-a, and may configure the DRB to UE 115-c. When the CU 410 configures radio bearers for core network 415-b (or the second slice), the CU 410 may use the radio capabilities and security parameters of the UE received from core network 415-b.

In some cases, the techniques described herein in which a UE 115 may be configured with a single access stratum entity (e.g., RRC entity) to serve multiple NAS entities, the NAS entity and the RRC entity may not be matched (e.g., if a NAS entity is in an idle state, the corresponding RRC may also be in an idle state). Accordingly, such configurations may reduce the occurrence of an RRC connection management procedure. The techniques described herein may allow a UE 115 to connect with multiple core networks 415 over one CU 410 node (e.g., or RAN node), decrease RRC signaling establishment/release signaling overhead, and decrease power consumption of a UE 115 due to reduced frequency of RRC state transition. In some cases, the techniques described herein may allow a UE 115 to achieve multiple concurrent network slices. A UE 115 may be able to support simultaneous service via multiple network slices when the multiple slice services are deployed in separate core networks 415.

In some cases, the techniques described herein may allow a UE 115 to perform efficient slice switching in which steps 420 through 455. In some cases, the techniques described herein may be utilized by a single reception/transmission UE 115. To perform the efficient slice switching, the UE context and radio bearers for the first slice may be suspended so that the UE 115 may switch to the second slice. Then when the service associated with the second slice is terminated, the UE context and radio bearers for the first slice may be resumed.

Accordingly, when performing slice switching at 460, the CU 410 (e.g., or RAN) may determine to suspend the context or configuration for the first network slice, and may indicate to UE 115-c in an RRC reconfiguration message that the context of the radio bearers related to the first slice are suspended. The CU 410 may transmit the indication of the suspension per radio bearer or per slice. To indicate the suspension to UE 115-c, the CU 410 may transmit the RRC reconfiguration message to DU 405-a. At 465, DU 405-a may transmit (e.g., relay) the RRC reconfiguration message to UE 115-c.

At 470, in response to the RRC reconfiguration message, UE 115-c may transmit an RRC reconfiguration complete message to DU 405-b. When UE 115-c receives the RRC reconfiguration with the suspension indication, if the indication is per radio bearer, UE 115-c may suspend the context for the indicated radio bearer. If the suspension indication is per network slice, UE 115-c may suspend the context for the indicated slice. UE 115-c may apply configurations for the second network slice (e.g., new configurations), and transmit an RRC reconfiguration complete message to the CU 410 (e.g., or RAN) via DU 405-b.

At 475, DU 405-b and the CU 410 may transmit one or more messages to suspend UE context associated with the first network slice. At 480, the CU 410 and core network 415-a may transmit one or more messages to suspend UE context associated with the first network slice. For example, the CU 410 may inform the DU 405, core network 415-a, or both to suspend UE context associated with the first network slice.

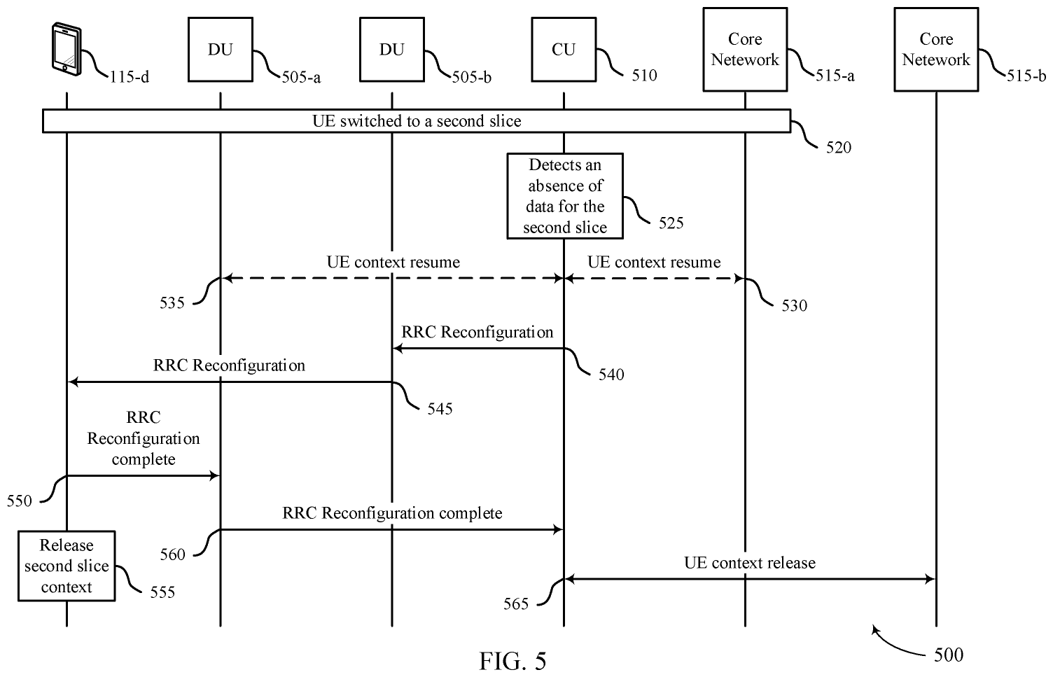

In accordance with the slice switching techniques described herein, when the UE 115 is switched from a first network slice to a second network slice (e.g., switched from core network 415-a to core network 415-b), the UE RRC state may be unchanged, and accordingly may reduce signaling overhead (e.g., Uu signaling overhead) and may reduce the amount of time it takes a UE 115 to switch slices. Additionally, the UE 115 may achieve an efficient switch back to a first network slice when the service associated with the second network slice is terminated (as described in more detail with reference to FIG. 5), thereby reducing signaling overhead associated with suspending and resuming network slices.

FIG. 5 illustrates an example of a process flow 500 that supports techniques for switching between network slices in accordance with aspects of the present disclosure. The process flow 500 may illustrate an example network slice switching procedure. For example, UE 115-d may determine to switch from using a first network slice to a second network slice. UE 115-d may perform such a slice switching procedure in the context of a split architecture including DUs 505-a and 505-b, CU 510, and core networks 515-a and 515-b, which may be examples of the corresponding wireless devices described with reference to FIGS. 1 through 4. In some cases, instead of UE 115-d implementing the slice switching procedure, a different type of wireless device (e.g., a base station, DU 505, or some other network device) may perform a same or similar procedure. Alternative examples of the following may be implemented, where some steps are performed in a different order than described or are not performed at all. In some cases, steps may include additional features not mentioned below, or further steps may be added. In some cases, the steps described with reference to FIG. 5 may be an extension of the steps described with reference to FIG. 4.

In some implementations, core network 515-a may serve a first network slice and core network 515-b may serve a second network slice. DU 505-a may be associated with core network 515-a (e.g., the first network slice) and DU 505-b may be associated with core network 515-b (e.g., the second network slice). CU 510 may support DU 505-a and DU 505-b, and may be connected with core network 515-a and core network 515-b. Each network slice may be supported by a different NAS entity, such that different NAS procedures may be associated with each slice. In some cases, UE 115-d may be configured with a single access stratum entity, such as a single RRC entity, to serve multiple NAS entities.

As described with reference to FIG. 4, in accordance with the techniques described herein, a UE 115 may achieve efficient slice switching. For example, a UE 115 may switch from a first network slice to a second network slice upon arrival of services associated with the second network slice. Similarly, the UE 115 may switch back to the first network slice when the services associated with the second network slice are terminated. For example, the CU 510 may detect that the service for the second slice has terminated and may initiated a release (e.g., an access node release) based on the detection. The CU 510 may release the connection and bearers associated with core network 515-b and the NAS associated with the second slice.

For example, at 520, UE 115-d may have switched to the second slice and may be receiving services associated with the second slice. At 525, CU 510 may detect an absence of data associated with the second slice. For example, the CU 510 (e.g., RAN) may detect that no data is transmitted for the second slice during a release timer and may determine to switch UE 115-d back to the first network slice so that UE 115-d may receive services associated with the first network slice. At 530 and 535, CU 510 may transmit a request for core network 515-a and DU 505-a to resume UE context and NG connection.

At 540, the CU 510 may reconfigure the UE over DU 505-b (e.g., over the second cell) and transmit an RRC reconfiguration message to DU 505-b. The RRC reconfiguration message may include an indication to release the context for core network 515-b (e.g., the second slice) and to resume context for core network 515-a (e.g., the first network slice). At 545, DU 505-b may transmit (e.g., relay) the RRC reconfiguration message to UE 115-d.

In response to receiving the RRC reconfiguration message, at 550, UE 115-d may transmit an RRC reconfiguration complete message to DU 505-a. At 555, UE 115-d may release the context associated with the second slice based on the RRC reconfiguration message. For example, UE 115-d may release the access stratum and NAS context for core network 515-b and resume the context for core network 515-a. At 560, DU 505-b may relay the RRC reconfiguration complete message to the CU 510.

In response to receiving the RRC reconfiguration complete message, at 565, the CU 510 may initiate an access node release for the second slice. Accordingly, the CU 510 may transmit an indication to core network 515-b to release the UE context.

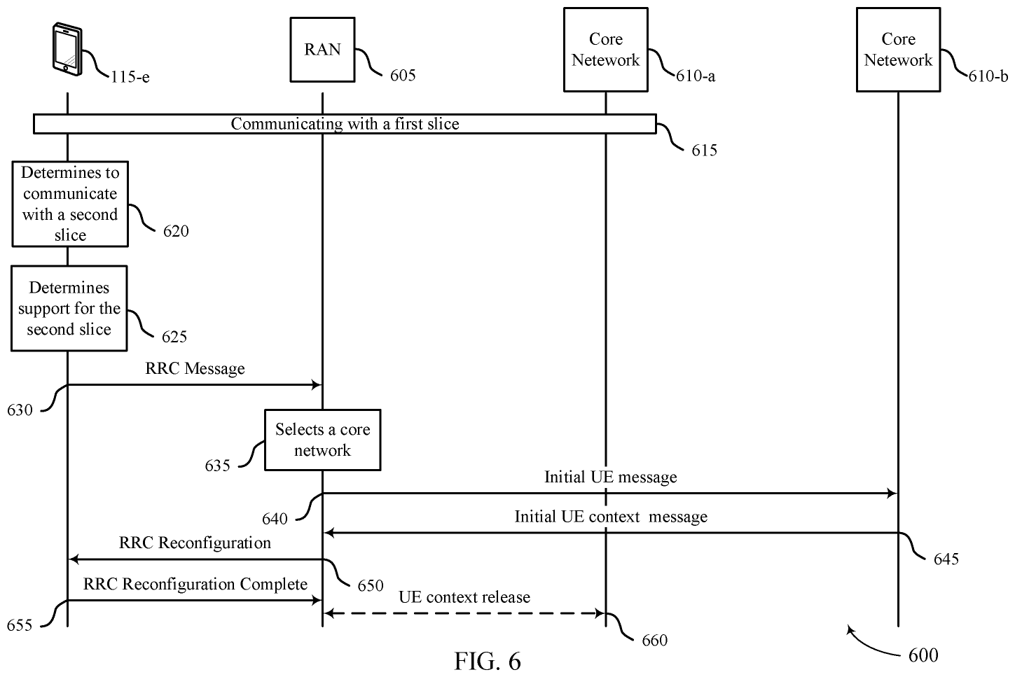

FIG. 6 illustrates an example of a process flow 600 that supports techniques for switching between network slices in accordance with aspects of the present disclosure. The process flow 600 may illustrate an example network slice switching procedure. For example, UE 115-e may determine to switch from using a first network slice to a second network slice. UE 115-e may perform such a slice switching procedure via a RAN 605, and core networks 610-a and 610-b, which may be examples of the corresponding wireless devices described with reference to FIGS. 1 through 5. In some cases, instead of UE 115-e implementing the slice switching procedure, a different type of wireless device (e.g., a base station, a RAN 605, or some other network device) may perform a same or similar procedure. Alternative examples of the following may be implemented, where some steps are performed in a different order than described or are not performed at all. In some cases, steps may include additional features not mentioned below, or further steps may be added.

In some implementations, core network 610-a may serve a first network slice and core network 610-b may serve a second network slice. A RAN 605 may be connected with core network 515-a and core network 515-b and UE 115-e may be connected with RAN 605. Each network slice may be supported by a different NAS entity, such that different NAS procedures may be associated with each slice. In some cases, UE 115-e may be configured with a single access stratum entity, such as a single RRC entity, to serve multiple NAS entities. In some cases, UE 115-e may be a single transmission/reception UE 115.

NAS signaling from two different NAS entities may be distinguished by different SRBs or by an explicit indication in the RRC layer. If UE 115-e has a NAS connection with core network 610-a, then for a first instance of uplink NAS signaling towards core network 610-b, UE 115-e may indicate the registered AMF information associated with the second network slice, where UE 115-e may transmit the uplink signaling to RAN 605, which RAN 605 may forward to core network 610-b. The first NAS signaling towards core network 610-b may be carried in an existing radio bearer (e.g., SRB1 or SRB2, where SRB1 may be associated with RRC message as well as NAS messages prior to the establishment of SRB2, and SRB2 may be associated with NAS messages). Based on UE initial context received from core network 610-b, RAN 605 may determine to setup new bearers or reuse existing radio bearers. Data for the first network slice and the second network slice may be carried in different DRBs. Based on the DRBs, UE 115-e and RAN 605 may determine which slice (or which core network 610) the data should be forwarded to. In some cases, data for the first network slice and the second network slice may be carried in the same DRB, where the message may include an indication of which network slice (or which core network 610) is associated with which core network 615 (e.g., slice indication, core network indication, NAS entity indication, or a combination thereof). UE 115-e may determine the supported slices via a system information block (SIB) in a current cell, and determine whether to register with the PLMN supporting the intended slice based on the SIB.

For example, at 615, UE 115-e may be communicating (e.g., transmitting, receiving, or both) in accordance with the first network slice. For example, UE 115-e may be authorized with (at least) a first slice and a second slice and UE 115-e may already have established communications with core network 610-a for the first slice via RAN 605.

At 620, UE 115-e may determine to communicate in accordance with a second slice. For example, one or more messages (e.g., application data) may arrive for the second slice. At 625, UE 115-e may determine support for the second slice. For example, UE 115-e may determine the PLMN associated with the second slice and determine whether UE 115-e is registered with the determined PLMN. In some cases, UE 115-e may determine information associated with the second slice, such as PLMN information via an SIB. If UE 115-e is registered with the PLMN associated with the second slice, then UE 115-e may transmit information associated with the PLMN, core network 610-b, or both. In some cases, UE 115-e may transmit the information with a NAS PDU to the RAN 605. For example, at 630, UE 115-e may transmit an RRC message to the RAN 605 including the NAS PDU and information. However, if UE 115-e determines that UE 115-e is not registered with the PLMN associated with the second slice, UE 115-e may perform a slice-based PLMN selection and register with the PLMN. For example, UE 115-e may prompt the registration procedure, at 630, by transmitting the RRC message to the RAN 605. Steps 630 through 660 may be performed in a similar or same manner as steps 435 through 480 were performed with reference to FIG. 4.

In some implementations, UE 115-e may register with multiple different network slices in accordance with dual-registration mechanisms. In some cases, in accordance with dual-registration, different slices may be supported by different connectivities and the network (e.g., RAN 605) may configure UE 115-e as if UE 115-e were a different UE 115 for each different slice. For each slice service, one RRC and NAS connection may be established. In some implementations, UE 115-e may determine PLMN support for a network slice, such as identifying slice information included in an SIB, where the slice information may be per PLMN. If UE 115-e determines that a second slice is supported in a PLMN that UE 115-e has not registered with, UE 115-e may perform a slice-based PLMN selection and register with the PLMN.

In some cases, the techniques described herein in which a UE 115 may be configured with a single access stratum entity (e.g., RRC entity) to serve multiple NAS entities, the NAS entity and the RRC entity may not be matched (e.g., if NAS entity is in an idle state, the corresponding RRC may also be in an idle state). Accordingly, such configurations may reduce the occurrence of an RRC connection management procedure. The techniques described herein may allow a UE 115 to connect with multiple core networks 610 over one RAN node 605, decrease RRC signaling establishment/release signaling overhead, and decrease power consumption of a UE 115 due to reduced frequency of RRC state transition. For example, RRC state transition may be reduced when one slice service arrives frequently. In some cases, the techniques described herein may allow a UE 115 to achieve multiple concurrent network slices. A UE 115 may be able to support simultaneous service via multiple network slices when the multiple slice services are deployed in separate core networks 610. In some cases, UE 115-e may achieve dual-registration with different core networks 610 or PLMNs connected with the same RAN node 605. For example, dual-registration may be achieved for a single reception/transmission UE 115.

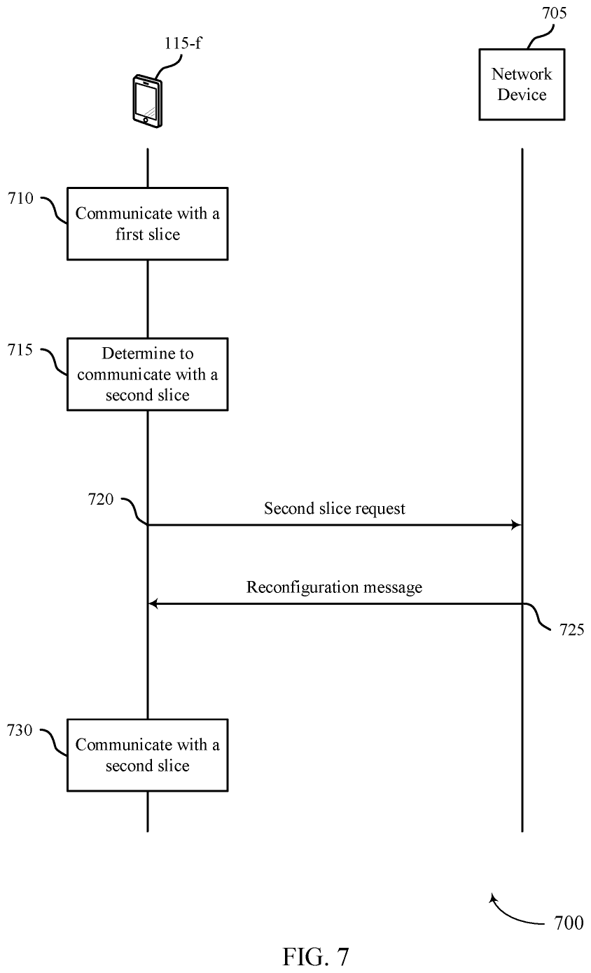

FIG. 7 illustrates an example of a process flow 700 that supports techniques for switching between network slices in accordance with aspects of the present disclosure. The process flow 700 may illustrate an example network slice switching procedure. For example, UE 115-f may determine to switch from using a first network slice to a second network slice. UE 115-f may perform such a slice switching procedure via a network device 705, which may be examples of the corresponding wireless devices described with reference to FIGS. 1 through 6. Network device 705 may represent a RAN, a DU, a CU, a core network, or a combination thereof. In some cases, instead of UE 115-f implementing the slice switching procedure, a different type of wireless device (e.g., a base station, a RAN, or some other network device) may perform a same or similar procedure. Alternative examples of the following may be implemented, where some steps are performed in a different order than described or are not performed at all. In some cases, steps may include additional features not mentioned below, or further steps may be added.

At 710, UE 115-f may identify that UE 115-f is in communication with a first slice of a network via a first control entity at UE 115-f.

At 715, UE 115-f may determine that UE 115-f is to further communicate with a second slice of the network. In some cases, UE 115-f may identify that the first slice is associated with a first core network and the second slice is supported by a second core network. UE 115-f may determine whether UE 115-f is registered with the second core network based on determining that UE 115-f is to further communicate with the second slice. Determining whether UE 115-f is registered with the second core network may include identifying that the first core network is associated with a first public land mobile network and the second core network is associated with a second public land mobile network, and determining whether UE 115-f is registered with the second public land mobile network.

In some cases, UE 115-f may identify a system information block including information associated with the second slice, where identifying that the second slice is supported by the second core network may be based on the system information block. In some cases, UE 115-f may determine that the UE is connected with a first distributed unit, where the first distributed unit may serve the first slice and a second distributed unit may serve the second slice.

In some implementations, UE 115-f may determining that UE 115-f is to further communicate with the second slice may include determining an arrival of application data associated with the second slice, and determining that the second slice is unsupported by the first distributed unit and is supported by the second distributed unit. UE 115-f may determine that a radio link quality between UE 115-f and the second distributed unit meets a threshold.

In some cases, determining that UE 115-f is to further communicate with the second slice may include determining an arrival of application data associated with the second slice, and determining that the second slice is supported by the RAN node.

The first slice and the second slice may be supported by a single Packet Data Convergence Protocol unit or by separate Packet Data Convergence Protocol units. The first slice may be associated with a first non-access stratum and the second slice may be associated with a second non-access stratum. The first control entity may be a RRC entity that carries the first non-access stratum and the second non-access stratum.

The first slice and the second slice may be supported by a single dedicated radio bearer or by separate dedicated radio bearers. In some cases, UE 115-f may receive an indication that the first slice is associated with a first core network, a first non-access stratum, or both and that the second slice is associated with a second core network, a second non-access stratum, or both based on the first slice and the second slice being supported by the single dedicated radio bearer.

At 720, UE 115-f may transmit a control message associated with the first control entity, where the control message may include a request pertaining to communications with the second slice. Transmitting the control message may include transmitting a non-access stratum protocol data unit including information associated with the second slice based on determining that UE 115-f is registered with the second core network. Transmitting the control message may include transmitting the non-access stratum protocol data unit including a service request to activate a protocol data unit session for the second slice.

Transmitting the control message may include determining whether there is an existing protocol data unit session for the second slice, transmitting the non-access stratum protocol data unit including a protocol data unit session establishment request to establish a protocol data unit session based on the determination of whether there is the existing protocol data unit session. Transmitting the control message may include transmitting a non-access stratum protocol data unit including a register request to register with the second core network based on determining that UE 115-f is unregistered with the second core network, and establishing a protocol data unit session with the second core network.

At 725, UE 115-f may receive in response to the control message and at the first control entity, a reconfiguration message indicating a configuration for using the second slice. UE 115-f may transmit the control message to the first distributed and receive the reconfiguration message from the first distributed unit. UE 115-f may determine that UE 115-f is connected to a RAN node, where the RAN node may serve the first slice and the second slice. Accordingly, UE 115-f may transmit the control message to the RAN node and receives the reconfiguration message from the RAN node. Receiving the reconfiguration message may include receive the reconfiguration message including an indication to suspend configurations with the first slice based on a configuration of the first slice. The first control entity may be a first RRC entity, the control message may be an RRC message, and the reconfiguration message may be an RRC reconfiguration message.

UE 115-f may transmit a reconfiguration complete message to the second distributed unit in response to receiving the reconfiguration message. UE 115-f may transmit a reconfiguration complete message to the RAN node in response to receiving the reconfiguration message.

At 730, UE 115-f may communicate with the second slice of the network based on the configuration. Communicating with the second slice of the network may include communicating with the second slice and the first slice concurrently based on a configuration of the first slice and the configuration of the second slice supporting concurrent usage.

UE 115-f may receive a second reconfiguration message including an indication for UE 115-f to release configurations associated with the second slice and to resume communications with the first slice. Accordingly, UE 115-f may release access stratum context and non-access stratum context associated with the second slice, and resume access stratum context and non-access stratum context associated with the first slice based on the second reconfiguration message.

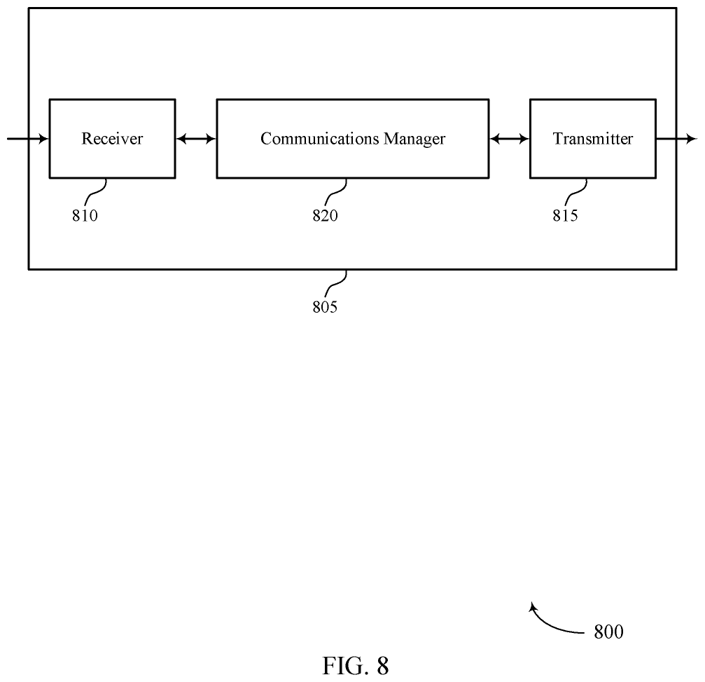

FIG. 8 shows a block diagram 800 of a device 805 that supports techniques for switching between network slices in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for switching between network slices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for switching between network slices). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of techniques for switching between network slices as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at UE in accordance with examples as disclosed herein. For example, the communications manager 820 may be configured as or otherwise support a means for identifying that the UE is in communication with a first slice of a network via a first control entity at the UE. The communications manager 820 may be configured as or otherwise support a means for determining that the UE is to further communicate with a second slice of the network. The communications manager 820 may be configured as or otherwise support a means for transmitting a control message associated with the first control entity, the control message including a request pertaining to communications with the second slice. The communications manager 820 may be configured as or otherwise support a means for receiving, in response to the control message and at the first control entity, a reconfiguration message indicating a configuration for using the second slice. The communications manager 820 may be configured as or otherwise support a means for communicating with the second slice of the network based on the configuration.

Additionally or alternatively, the communications manager 820 may support wireless communications at UE in accordance with examples as disclosed herein. For example, the communications manager 820 may be configured as or otherwise support a means for identifying that the UE is in communication with a first slice of a first network via a first control entity at the UE. The communications manager 820 may be configured as or otherwise support a means for determining that the UE is to further communicate with a second slice of a second network via a second control entity at the UE. The communications manager 820 may be configured as or otherwise support a means for verifying that the second slice is supported by the second network. The communications manager 820 may be configured as or otherwise support a means for registering with the second network based on the second slice being supported by the second network.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for more efficient utilization of communication resources.

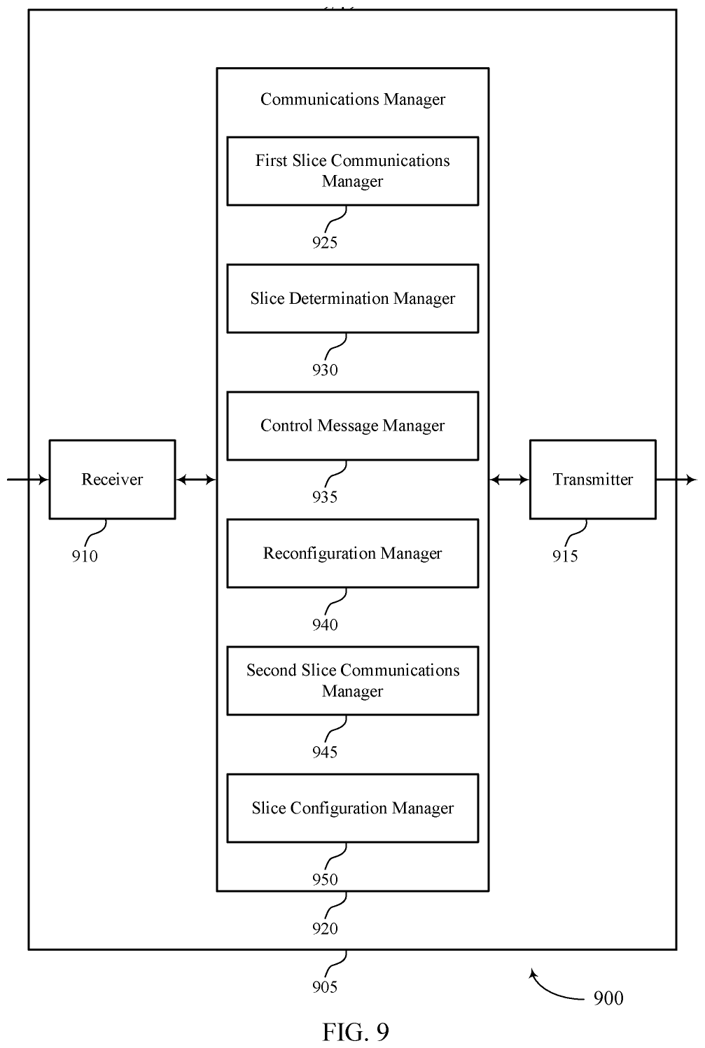

FIG. 9 shows a block diagram 900 of a device 905 that supports techniques for switching between network slices in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to techniques for switching between network slices). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to techniques for switching between network slices). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of techniques for switching between network slices as described herein. For example, the communications manager 920 may include a first slice communications manager 925, a slice determination manager 930, a control message manager 935, a reconfiguration manager 940, a second slice communications manager 945, a slice configuration manager 950, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at UE in accordance with examples as disclosed herein. The first slice communications manager 925 may be configured as or otherwise support a means for identifying that the UE is in communication with a first slice of a network via a first control entity at the UE. The slice determination manager 930 may be configured as or otherwise support a means for determining that the UE is to further communicate with a second slice of the network. The control message manager 935 may be configured as or otherwise support a means for transmitting a control message associated with the first control entity, the control message including a request pertaining to communications with the second slice. The reconfiguration manager 940 may be configured as or otherwise support a means for receiving, in response to the control message and at the first control entity, a reconfiguration message indicating a configuration for using the second slice. The second slice communications manager 945 may be configured as or otherwise support a means for communicating with the second slice of the network based on the configuration.

Additionally or alternatively, the communications manager 920 may support wireless communications at UE in accordance with examples as disclosed herein. The first slice communications manager 925 may be configured as or otherwise support a means for identifying that the UE is in communication with a first slice of a first network via a first control entity at the UE. The slice determination manager 930 may be configured as or otherwise support a means for determining that the UE is to further communicate with a second slice of a second network via a second control entity at the UE. The slice configuration manager 950 may be configured as or otherwise support a means for verifying that the second slice is supported by the second network. The second slice communications manager 945 may be configured as or otherwise support a means for registering with the second network based on the second slice being supported by the second network.

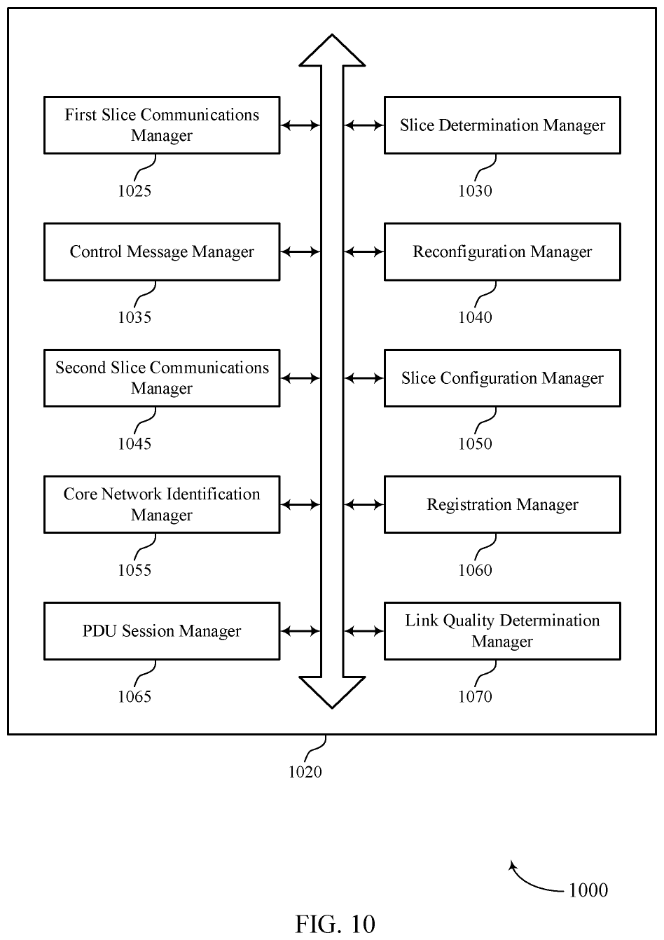

FIG. 10 shows a block diagram 1000 of a communications manager 1020 that supports techniques for switching between network slices in accordance with aspects of the present disclosure. The communications manager 1020 may be an example of aspects of a communications manager 820, a communications manager 920, or both, as described herein. The communications manager 1020, or various components thereof, may be an example of means for performing various aspects of techniques for switching between network slices as described herein. For example, the communications manager 1020 may include a first slice communications manager 1025, a slice determination manager 1030, a control message manager 1035, a reconfiguration manager 1040, a second slice communications manager 1045, a slice configuration manager 1050, a core network identification manager 1055, a registration manager 1060, a PDU session manager 1065, a Link quality determination manager 1070, or any combination thereof. Each of these components may communicate, directly or indirectly, with one another (e.g., via one or more buses).

The communications manager 1020 may support wireless communications at UE in accordance with examples as disclosed herein. The first slice communications manager 1025 may be configured as or otherwise support a means for identifying that the UE is in communication with a first slice of a network via a first control entity at the UE. The slice determination manager 1030 may be configured as or otherwise support a means for determining that the UE is to further communicate with a second slice of the network. The control message manager 1035 may be configured as or otherwise support a means for transmitting a control message associated with the first control entity, the control message including a request pertaining to communications with the second slice. The reconfiguration manager 1040 may be configured as or otherwise support a means for receiving, in response to the control message and at the first control entity, a reconfiguration message indicating a configuration for using the second slice. The second slice communications manager 1045 may be configured as or otherwise support a means for communicating with the second slice of the network based on the configuration.

In some examples, the core network identification manager 1055 may be configured as or otherwise support a means for identifying that the first slice is associated with a first core network and the second slice is supported by a second core network. In some examples, the registration manager 1060 may be configured as or otherwise support a means for determining whether the UE is registered with the second core network based on determining that the UE is to further communicate with the second slice.

In some examples, to support transmitting the control message, the control message manager 1035 may be configured as or otherwise support a means for transmitting a non-access stratum protocol data unit including information associated with the second slice based on determining that the UE is registered with the second core network.

In some examples, to support transmitting the control message, the control message manager 1035 may be configured as or otherwise support a means for transmitting the non-access stratum protocol data unit including a service request to activate a protocol data unit session for the second slice.

In some examples, to support transmitting the control message, the PDU session manager 1065 may be configured as or otherwise support a means for determining whether there is an existing protocol data unit session for the second slice. In some examples, to support transmitting the control message, the control message manager 1035 may be configured as or otherwise support a means for transmitting the non-access stratum protocol data unit including a protocol data unit session establishment request to establish a protocol data unit session based on the determination of whether there is the existing protocol data unit session.

In some examples, to support transmitting the control message, the control message manager 1035 may be configured as or otherwise support a means for transmitting a non-access stratum protocol data unit including a register request to register with the second core network based on determining that the UE is unregistered with the second core network. In some examples, to support transmitting the control message, the PDU session manager 1065 may be configured as or otherwise support a means for establishing a protocol data unit session with the second core network.

In some examples, to support determining whether the UE is registered with the second core network, the core network identification manager 1055 may be configured as or otherwise support a means for identifying that the first core network is associated with a first public land mobile network and the second core network is associated with a second public land mobile network. In some examples, to support determining whether the UE is registered with the second core network, the registration manager 1060 may be configured as or otherwise support a means for determining whether the UE is registered with the second public land mobile network.

In some examples, the core network identification manager 1055 may be configured as or otherwise support a means for identifying a system information block including information associated with the second slice, where identifying that the second slice is supported by the second core network is based on the system information block.

In some examples, the control message manager 1035 may be configured as or otherwise support a means for determining that the UE is connected with a first distributed unit, the first distributed unit serving the first slice and a second distributed unit serving the second slice, where the UE transmits the control message to the first distributed unit and receives the reconfiguration message from the first distributed unit.

In some examples, to support determining that the UE is to further communicate with the second slice, the second slice communications manager 1045 may be configured as or otherwise support a means for determining an arrival of application data associated with the second slice. In some examples, to support determining that the UE is to further communicate with the second slice, the second slice communications manager 1045 may be configured as or otherwise support a means for determining that the second slice is unsupported by the first distributed unit and is supported by the second distributed unit.

In some examples, the Link quality determination manager 1070 may be configured as or otherwise support a means for determining that a radio link quality between the UE and the second distributed unit meets a threshold.

In some examples, the control message manager 1035 may be configured as or otherwise support a means for transmitting a reconfiguration complete message to the second distributed unit in response to receiving the reconfiguration message.

In some examples, the control message manager 1035 may be configured as or otherwise support a means for determining that the UE is connected to a RAN node, the RAN node serving the first slice and the second slice, where the UE transmits the control message to the RAN node and receives the reconfiguration message from the RAN node.

In some examples, to support determining that the UE is to further communicate with the second slice, the second slice communications manager 1045 may be configured as or otherwise support a means for determining an arrival of application data associated with the second slice. In some examples, to support determining that the UE is to further communicate with the second slice, the second slice communications manager 1045 may be configured as or otherwise support a means for determining that the second slice is supported by the RAN node.

In some examples, the control message manager 1035 may be configured as or otherwise support a means for transmitting a reconfiguration complete message to the RAN node in response to receiving the reconfiguration message.

In some examples, to support communicating with the second slice of the network, the second slice communications manager 1045 may be configured as or otherwise support a means for communicating with the second slice and the first slice concurrently based on a configuration of the first slice and the configuration of the second slice supporting concurrent usage.

In some examples, to support receiving the reconfiguration message, the control message manager 1035 may be configured as or otherwise support a means for receiving the reconfiguration message including an indication to suspend configurations with the first slice based on a configuration of the first slice.

In some examples, the control message manager 1035 may be configured as or otherwise support a means for receiving a second reconfiguration message including an indication for the UE to release configurations associated with the second slice and to resume communications with the first slice.

In some examples, the second slice communications manager 1045 may be configured as or otherwise support a means for releasing access stratum context and non-access stratum context associated with the second slice. In some examples, the first slice communications manager 1025 may be configured as or otherwise support a means for resuming access stratum context and non-access stratum context associated with the first slice based on the second reconfiguration message.

In some examples, the first slice and the second slice are supported by a single Packet Data Convergence Protocol unit or by separate Packet Data Convergence Protocol units.

In some examples, the first slice and the second slice are supported by a single dedicated radio bearer or by separate dedicated radio bearers.

In some examples, the core network identification manager 1055 may be configured as or otherwise support a means for receiving an indication that the first slice is associated with a first core network, a first non-access stratum, or both and that the second slice is associated with a second core network, a second non-access stratum, or both based on the first slice and the second slice being supported by the single dedicated radio bearer.

In some examples, the first slice is associated with a first non-access stratum and the second slice is associated with a second non-access stratum. In some examples, the first control entity is an RRC entity that carries the first non-access stratum and the second non-access stratum.

In some examples, the first control entity is a first RRC entity, the control message is an RRC message, and the reconfiguration message is an RRC reconfiguration message.

Additionally or alternatively, the communications manager 1020 may support wireless communications at UE in accordance with examples as disclosed herein. In some examples, the first slice communications manager 1025 may be configured as or otherwise support a means for identifying that the UE is in communication with a first slice of a first network via a first control entity at the UE. In some examples, the slice determination manager 1030 may be configured as or otherwise support a means for determining that the UE is to further communicate with a second slice of a second network via a second control entity at the UE. The slice configuration manager 1050 may be configured as or otherwise support a means for verifying that the second slice is supported by the second network. In some examples, the second slice communications manager 1045 may be configured as or otherwise support a means for registering with the second network based on the second slice being supported by the second network.

In some examples, the slice configuration manager 1050 may be configured as or otherwise support a means for receiving, via a system information block, supported slice information for the second network, where the verifying is based on the supported slice information.

In some examples, the first network and the second network are public land mobile networks (PLMNs).

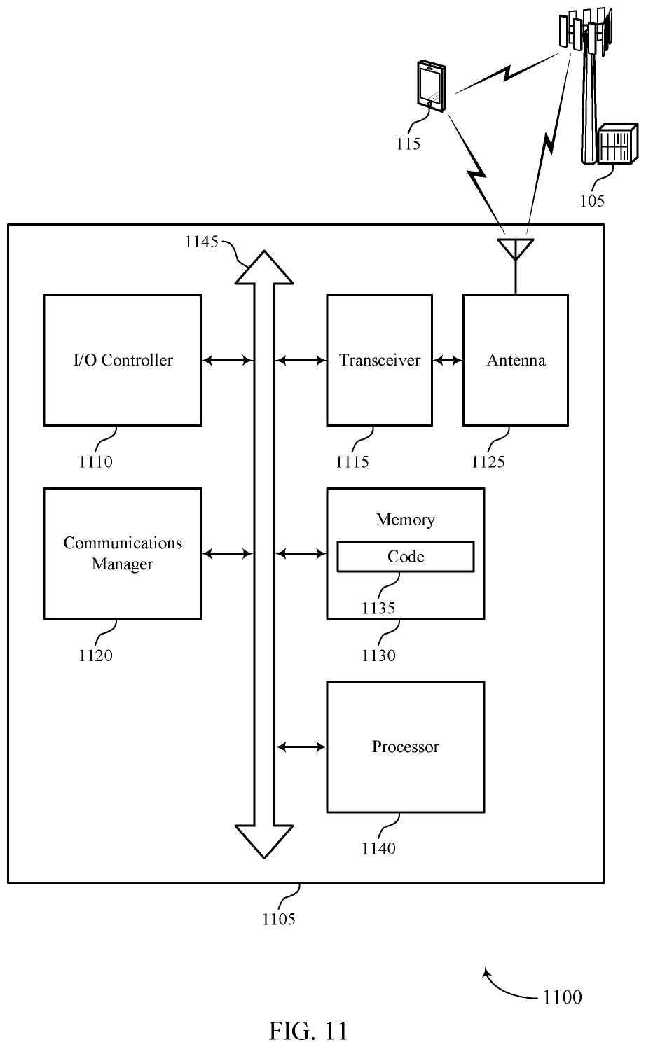

FIG. 11 shows a diagram of a system 1100 including a device 1105 that supports techniques for switching between network slices in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting techniques for switching between network slices). For example, the device 1105 or a component of the device 1105 may include a processor 1140 and memory 1130 coupled to the processor 1140, the processor 1140 and memory 1130 configured to perform various functions described herein.

The communications manager 1120 may support wireless communications at UE in accordance with examples as disclosed herein. For example, the communications manager 1120 may be configured as or otherwise support a means for identifying that the UE is in communication with a first slice of a network via a first control entity at the UE. The communications manager 1120 may be configured as or otherwise support a means for determining that the UE is to further communicate with a second slice of the network. The communications manager 1120 may be configured as or otherwise support a means for transmitting a control message associated with the first control entity, the control message including a request pertaining to communications with the second slice. The communications manager 1120 may be configured as or otherwise support a means for receiving, in response to the control message and at the first control entity, a reconfiguration message indicating a configuration for using the second slice. The communications manager 1120 may be configured as or otherwise support a means for communicating with the second slice of the network based on the configuration.

Additionally or alternatively, the communications manager 1120 may support wireless communications at UE in accordance with examples as disclosed herein. For example, the communications manager 1120 may be configured as or otherwise support a means for identifying that the UE is in communication with a first slice of a first network via a first control entity at the UE. The communications manager 1120 may be configured as or otherwise support a means for determining that the UE is to further communicate with a second slice of a second network via a second control entity at the UE. The communications manager 1120 may be configured as or otherwise support a means for verifying that the second slice is supported by the second network. The communications manager 1120 may be configured as or otherwise support a means for registering with the second network based on the second slice being supported by the second network.

By including or configuring the communications manager 1120 in accordance with examples as described herein, the device 1105 may support techniques for reduced latency, improved user experience related to reduced processing, reduced power consumption, and more efficient utilization of communication resources.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of techniques for switching between network slices as described herein, or the processor 1140 and the memory 1130 may be otherwise configured to perform or support such operations.

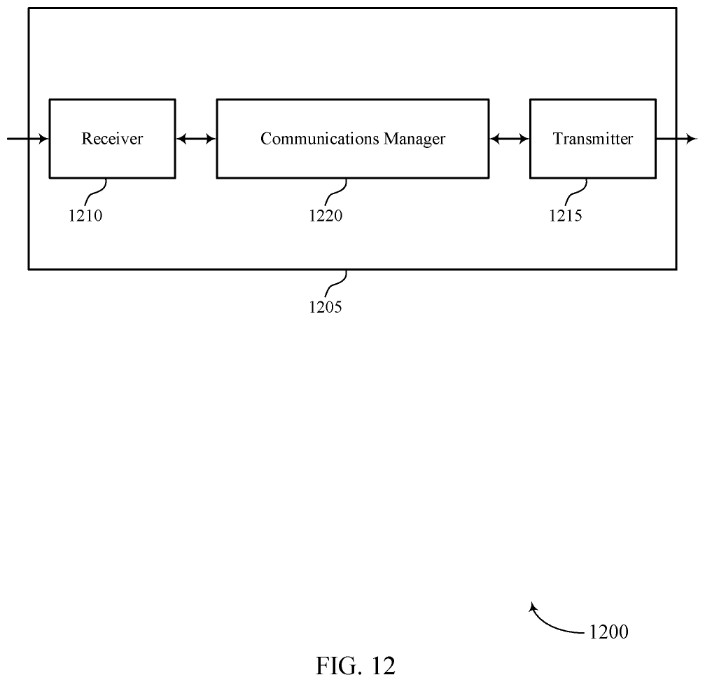

FIG. 12 shows a block diagram 1200 of a device 1205 that supports techniques for switching between network slices in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to techniques for switching between network slices). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to techniques for switching between network slices). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of techniques for switching between network slices as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications a wireless device in accordance with examples as disclosed herein. For example, the communications manager 1220 may be configured as or otherwise support a means for identifying that a UE is in communication with a first slice of a network. The communications manager 1220 may be configured as or otherwise support a means for determining that the UE is to further communicate with a second slice of the network. The communications manager 1220 may be configured as or otherwise support a means for receiving a control message associated with a first control entity, the control message including a request pertaining to communications with the second slice. The communications manager 1220 may be configured as or otherwise support a means for transmitting, in response to the control message and at the first control entity, a reconfiguration message indicating a configuration for using the second slice.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for more efficient utilization of communication resources.

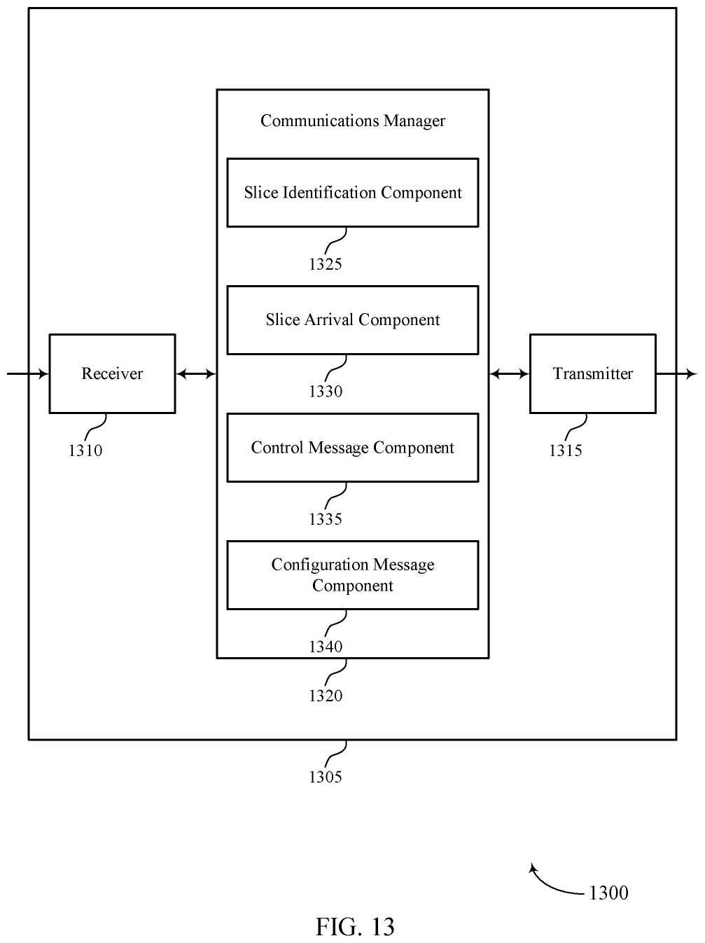

FIG. 13 shows a block diagram 1300 of a device 1305 that supports techniques for switching between network slices in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to techniques for switching between network slices). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to techniques for switching between network slices). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of techniques for switching between network slices as described herein. For example, the communications manager 1320 may include a slice identification component 1325, a slice arrival component 1330, a control message component 1335, a configuration message component 1340, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications a wireless device in accordance with examples as disclosed herein. The slice identification component 1325 may be configured as or otherwise support a means for identifying that a UE is in communication with a first slice of a network. The slice arrival component 1330 may be configured as or otherwise support a means for determining that the UE is to further communicate with a second slice of the network. The control message component 1335 may be configured as or otherwise support a means for receiving a control message associated with a first control entity, the control message including a request pertaining to communications with the second slice. The configuration message component 1340 may be configured as or otherwise support a means for transmitting, in response to the control message and at the first control entity, a reconfiguration message indicating a configuration for using the second slice.

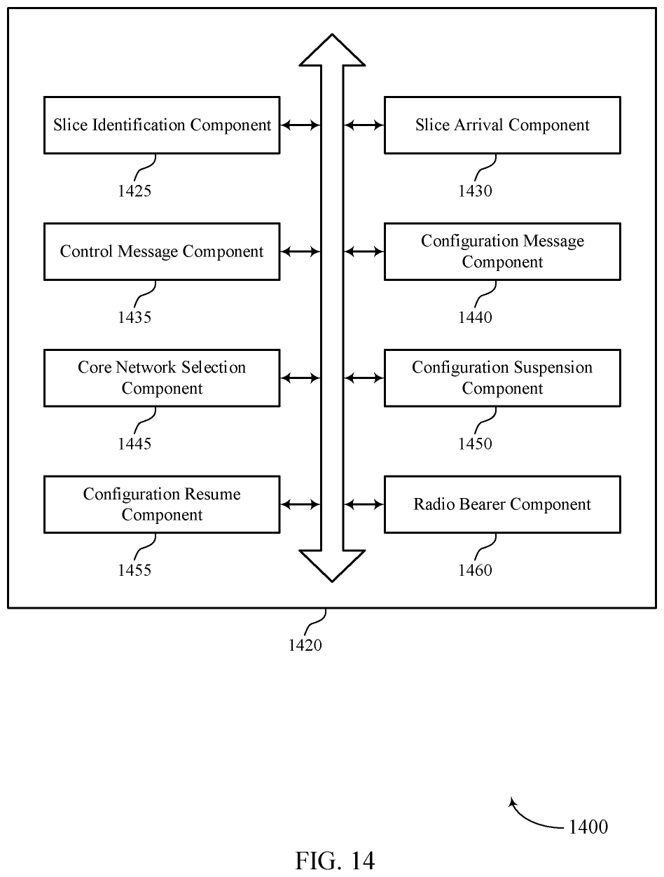

FIG. 14 shows a block diagram 1400 of a communications manager 1420 that supports techniques for switching between network slices in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of techniques for switching between network slices as described herein. For example, the communications manager 1420 may include a slice identification component 1425, a slice arrival component 1430, a control message component 1435, a configuration message component 1440, a core network selection component 1445, a configuration suspension component 1450, a configuration resume component 1455, a radio bearer component 1460, or any combination thereof. Each of these components may communicate, directly or indirectly, with one another (e.g., via one or more buses).

The communications manager 1420 may support wireless communications a wireless device in accordance with examples as disclosed herein. The slice identification component 1425 may be configured as or otherwise support a means for identifying that a UE is in communication with a first slice of a network. The slice arrival component 1430 may be configured as or otherwise support a means for determining that the UE is to further communicate with a second slice of the network. The control message component 1435 may be configured as or otherwise support a means for receiving a control message associated with a first control entity, the control message including a request pertaining to communications with the second slice. The configuration message component 1440 may be configured as or otherwise support a means for transmitting, in response to the control message and at the first control entity, a reconfiguration message indicating a configuration for using the second slice.

In some examples, the first slice is supported by a first core network and the second slice is supported by a second core network, and the core network selection component 1445 may be configured as or otherwise support a means for selecting the second core network based on the control message. In some examples, the first slice is supported by a first core network and the second slice is supported by a second core network, and the control message component 1435 may be configured as or otherwise support a means for relaying the control message to the second core network.

In some examples, the control message component 1435 may be configured as or otherwise support a means for receiving a UE context message and a non-access stratum protocol data unit associated with a second core network, where the non-access stratum protocol data unit includes a service accept message or a protocol data unit session establishment accept message based on the control message from the UE.

In some examples, the radio bearer component 1460 may be configured as or otherwise support a means for establishing a signaling radio bearer for the non-access stratum protocol data unit associated with the second core network.

In some examples, the radio bearer component 1460 may be configured as or otherwise support a means for determining a reconfiguration of an existing signaling radio bearer for the non-access stratum protocol data unit associated with the second core network.

In some examples, the radio bearer component 1460 may be configured as or otherwise support a means for establishing a dedicated radio bearer for the non-access stratum protocol data unit associated with the second core network.

In some examples, the configuration suspension component 1450 may be configured as or otherwise support a means for determining to suspend configurations associated with the first slice based on a configuration of the first slice.

In some examples, to support transmitting the reconfiguration message, the control message component 1435 may be configured as or otherwise support a means for transmitting the reconfiguration message including an indication to release configurations associated with the first slice.

In some examples, the slice identification component 1425 may be configured as or otherwise support a means for identifying an absence of data associated with the second slice while a release timer is running. In some examples, the configuration resume component 1455 may be configured as or otherwise support a means for determining to resume communications with the first slice based on the absence of data.

In some examples, the control message component 1435 may be configured as or otherwise support a means for transmitting, to one or more other wireless devices, a UE context message including an indication to resume communications associated with the first slice. In some examples, the control message component 1435 may be configured as or otherwise support a means for transmitting a second reconfiguration message indicating the UE to release context associated with the second slice and to resume context associated with the first slice.

In some examples, the wireless device includes a centralized unit and a distributed unit or includes a RAN node.

In some examples, the first slice and the second slice are supported by a single Packet Data Convergence Protocol unit or by separate Packet Data Convergence Protocol units.

In some examples, the first slice and the second slice are supported by a single dedicated radio bearer or by separate dedicated radio bearers.

In some examples, the configuration message component 1440 may be configured as or otherwise support a means for transmitting an indication that the first slice is associated with a first core network, a first non-access stratum, or both and that the second slice is associated with a second core network, a second non-access stratum, or both based on the first slice and the second slice being supported by the single dedicated radio bearer.

In some examples, the first control entity is a first RRC entity, the control message is an RRC message, and the reconfiguration message is an RRC reconfiguration message.

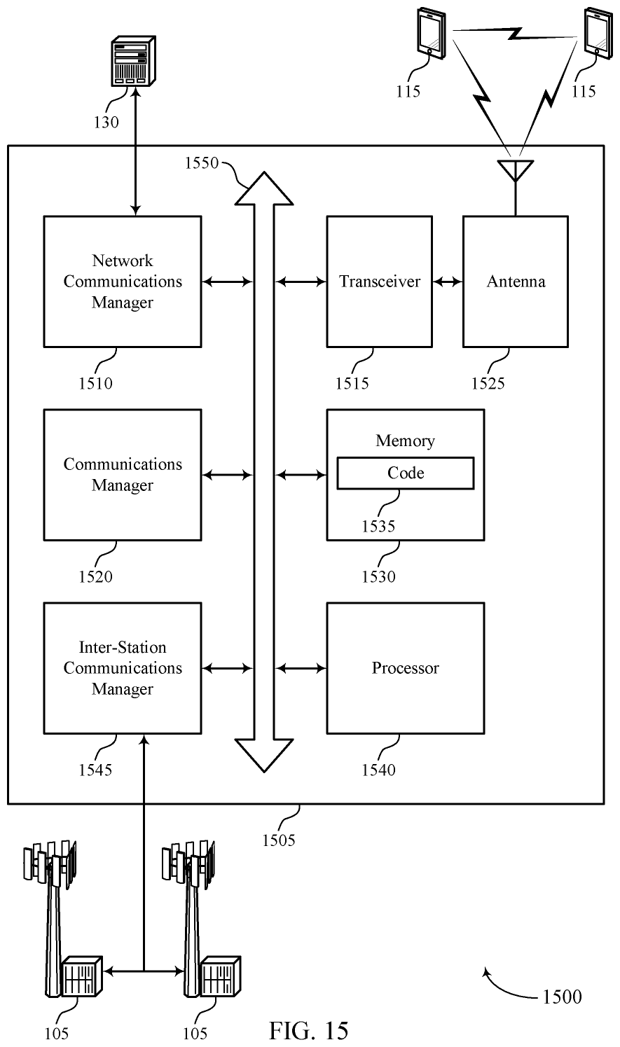

FIG. 15 shows a diagram of a system 1500 including a device 1505 that supports techniques for switching between network slices in accordance with aspects of the present disclosure. The device 1505 may be an example of or include the components of a device 1205, a device 1305, or a base station 105 as described herein.

The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting techniques for switching between network slices). For example, the device 1505 or a component of the device 1505 may include a processor 1540 and memory 1530 coupled to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communications a wireless device in accordance with examples as disclosed herein. For example, the communications manager 1520 may be configured as or otherwise support a means for identifying that a UE is in communication with a first slice of a network. The communications manager 1520 may be configured as or otherwise support a means for determining that the UE is to further communicate with a second slice of the network.

The communications manager 1520 may be configured as or otherwise support a means for receiving a control message associated with a first control entity, the control message including a request pertaining to communications with the second slice. The communications manager 1520 may be configured as or otherwise support a means for transmitting, in response to the control message and at the first control entity, a reconfiguration message indicating a configuration for using the second slice.

By including or configuring the communications manager 1520 in accordance with examples as described herein, the device 1505 may support techniques for reduced latency, improved user experience related to reduced processing, reduced power consumption, and more efficient utilization of communication resources.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of techniques for switching between network slices as described herein, or the processor 1540 and the memory 1530 may be otherwise configured to perform or support such operations.

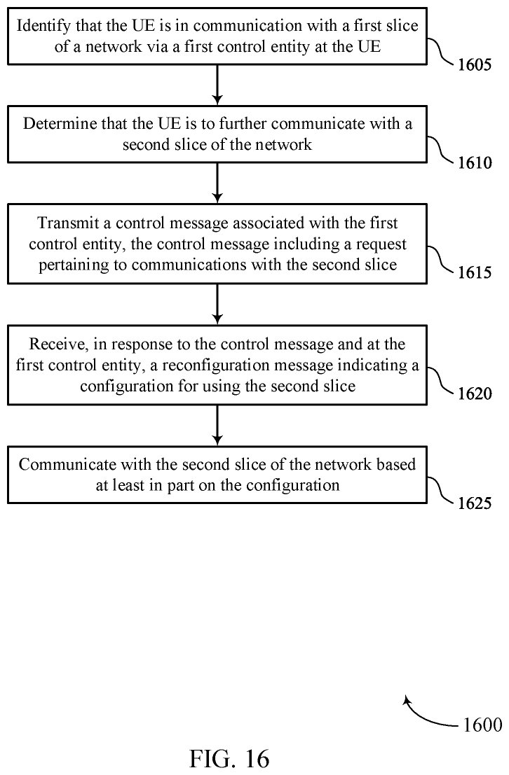

FIG. 16 shows a flowchart illustrating a method 1600 that supports techniques for switching between network slices in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1605, the method may include identifying that the UE is in communication with a first slice of a network via a first control entity at the UE. The operations of 1605 may be performed in accordance with examples as disclosed herein. In some examples, aspects of the operations of 1605 may be performed by a first slice communications manager 1025 as described with reference to FIG. 10.

At 1610, the method may include determining that the UE is to further communicate with a second slice of the network. The operations of 1610 may be performed in accordance with examples as disclosed herein. In some examples, aspects of the operations of 1610 may be performed by a slice determination manager 1030 as described with reference to FIG. 10.

At 1615, the method may include transmitting a control message associated with the first control entity, the control message including a request pertaining to communications with the second slice. The operations of 1615 may be performed in accordance with examples as disclosed herein. In some examples, aspects of the operations of 1615 may be performed by a control message manager 1035 as described with reference to FIG. 10.

At 1620, the method may include receiving, in response to the control message and at the first control entity, a reconfiguration message indicating a configuration for using the second slice. The operations of 1620 may be performed in accordance with examples as disclosed herein. In some examples, aspects of the operations of 1620 may be performed by a reconfiguration manager 1040 as described with reference to FIG. 10.

At 1625, the method may include communicating with the second slice of the network based on the configuration. The operations of 1625 may be performed in accordance with examples as disclosed herein. In some examples, aspects of the operations of 1625 may be performed by a second slice communications manager 1045 as described with reference to FIG. 10.

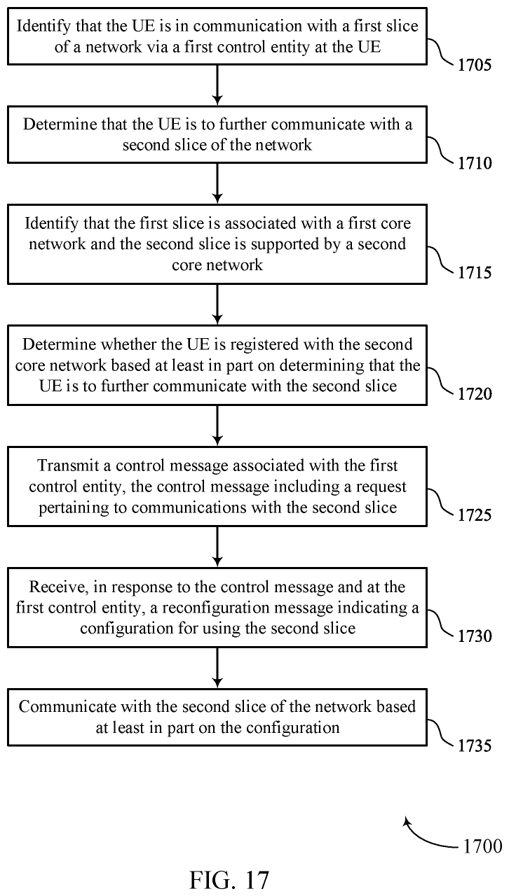

FIG. 17 shows a flowchart illustrating a method 1700 that supports techniques for switching between network slices in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1705, the method may include identifying that the UE is in communication with a first slice of a network via a first control entity at the UE. The operations of 1705 may be performed in accordance with examples as disclosed herein. In some examples, aspects of the operations of 1705 may be performed by a first slice communications manager 1025 as described with reference to FIG. 10.

At 1710, the method may include determining that the UE is to further communicate with a second slice of the network. The operations of 1710 may be performed in accordance with examples as disclosed herein. In some examples, aspects of the operations of 1710 may be performed by a slice determination manager 1030 as described with reference to FIG. 10.

At 1715, the method may include identifying that the first slice is associated with a first core network and the second slice is supported by a second core network. The operations of 1715 may be performed in accordance with examples as disclosed herein. In some examples, aspects of the operations of 1715 may be performed by a core network identification manager 1055 as described with reference to FIG. 10.

At 1720, the method may include determining whether the UE is registered with the second core network based on determining that the UE is to further communicate with the second slice. The operations of 1720 may be performed in accordance with examples as disclosed herein. In some examples, aspects of the operations of 1720 may be performed by a registration manager 1060 as described with reference to FIG. 10.

At 1725, the method may include transmitting a control message associated with the first control entity, the control message including a request pertaining to communications with the second slice. The operations of 1725 may be performed in accordance with examples as disclosed herein. In some examples, aspects of the operations of 1725 may be performed by a control message manager 1035 as described with reference to FIG. 10.

At 1730, the method may include receiving, in response to the control message and at the first control entity, a reconfiguration message indicating a configuration for using the second slice. The operations of 1730 may be performed in accordance with examples as disclosed herein. In some examples, aspects of the operations of 1730 may be performed by a reconfiguration manager 1040 as described with reference to FIG. 10.

At 1735, the method may include communicating with the second slice of the network based on the configuration. The operations of 1735 may be performed in accordance with examples as disclosed herein. In some examples, aspects of the operations of 1735 may be performed by a second slice communications manager 1045 as described with reference to FIG. 10.

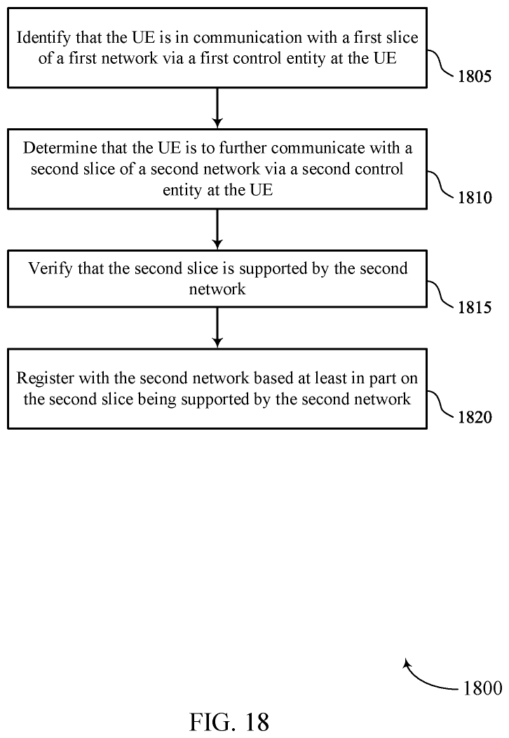

FIG. 18 shows a flowchart illustrating a method 1800 that supports techniques for switching between network slices in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally or alternatively, the UE may perform aspects of the described functions using special-purpose hardware.

At 1805, the method may include identifying that the UE is in communication with a first slice of a first network via a first control entity at the UE. The operations of 1805 may be performed in accordance with examples as disclosed herein. In some examples, aspects of the operations of 1805 may be performed by a first slice communications manager 1025 as described with reference to FIG. 10.

At 1810, the method may include determining that the UE is to further communicate with a second slice of a second network via a second control entity at the UE. The operations of 1810 may be performed in accordance with examples as disclosed herein. In some examples, aspects of the operations of 1810 may be performed by a slice determination manager 1030 as described with reference to FIG. 10.

At 1815, the method may include verifying that the second slice is supported by the second network. The operations of 1815 may be performed in accordance with examples as disclosed herein. In some examples, aspects of the operations of 1815 may be performed by a slice configuration manager 1050 as described with reference to FIG. 10.

At 1820, the method may include registering with the second network based on the second slice being supported by the second network. The operations of 1820 may be performed in accordance with examples as disclosed herein. In some examples, aspects of the operations of 1820 may be performed by a second slice communications manager 1045 as described with reference to FIG. 10.

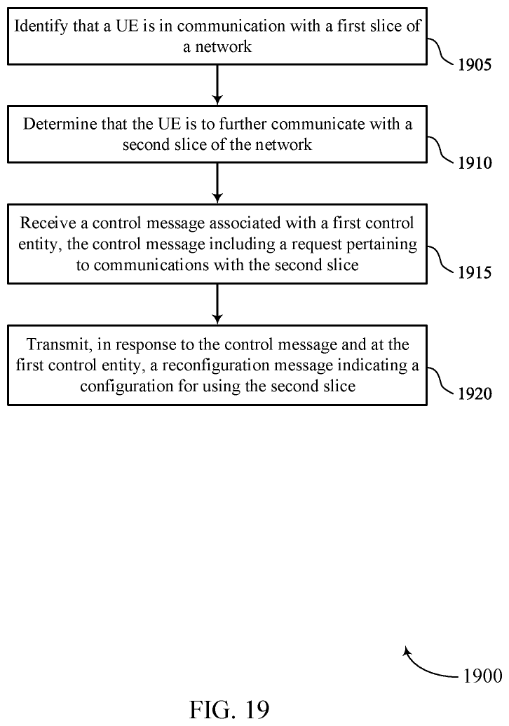

FIG. 19 shows a flowchart illustrating a method 1900 that supports techniques for switching between network slices in accordance with aspects of the present disclosure. The operations of the method 1900 may be implemented by a base station or its components as described herein. For example, the operations of the method 1900 may be performed by a base station 105 as described with reference to FIGS. 1 through 7 and 12 through 15. In some examples, a base station may execute a set of instructions to control the functional elements of the base station to perform the described functions. Additionally or alternatively, the base station may perform aspects of the described functions using special-purpose hardware.

At 1905, the method may include identifying that a UE is in communication with a first slice of a network. The operations of 1905 may be performed in accordance with examples as disclosed herein. In some examples, aspects of the operations of 1905 may be performed by a slice identification component 1425 as described with reference to FIG. 14.

At 1910, the method may include determining that the UE is to further communicate with a second slice of the network. The operations of 1910 may be performed in accordance with examples as disclosed herein. In some examples, aspects of the operations of 1910 may be performed by a slice arrival component 1430 as described with reference to FIG. 14.

At 1915, the method may include receiving a control message associated with a first control entity, the control message including a request pertaining to communications with the second slice. The operations of 1915 may be performed in accordance with examples as disclosed herein. In some examples, aspects of the operations of 1915 may be performed by a control message component 1435 as described with reference to FIG. 14.

At 1920, the method may include transmitting, in response to the control message and at the first control entity, a reconfiguration message indicating a configuration for using the second slice. The operations of 1920 may be performed in accordance with examples as disclosed herein. In some examples, aspects of the operations of 1920 may be performed by a configuration message component 1440 as described with reference to FIG. 14.

The following provides an overview of aspects of the present disclosure:

Aspect 1: A method for wireless communications at a UE, comprising: identifying that the UE is in communication with a first slice of a network via a first control entity at the UE; determining that the UE is to further communicate with a second slice of the network; transmitting a control message associated with the first control entity, the control message including a request pertaining to communications with the second slice; receiving, in response to the control message and at the first control entity, a reconfiguration message indicating a configuration for using the second slice; and communicating with the second slice of the network based at least in part on the configuration.

Aspect 2: The method of aspect 1, further comprising: identifying that the first slice is associated with a first core network and the second slice is supported by a second core network; and determining whether the UE is registered with the second core network based at least in part on determining that the UE is to further communicate with the second slice.

Aspect 3: The method of aspect 2, wherein transmitting the control message further comprises: transmitting a non-access stratum protocol data unit comprising information associated with the second slice based at least in part on determining that the UE is registered with the second core network.

Aspect 4: The method of aspect 3, wherein transmitting the control message further comprises: transmitting the non-access stratum protocol data unit comprising a service request to activate a protocol data unit session for the second slice.

Aspect 5: The method of any of aspects 3 through 4, wherein transmitting the control message further comprises: determining whether there is an existing protocol data unit session for the second slice; and transmitting the non-access stratum protocol data unit comprising a protocol data unit session establishment request to establish a protocol data unit session based at least in part on the determination of whether there is the existing protocol data unit session.

Aspect 6: The method of any of aspects 2 through 5, wherein transmitting the control message further comprises: transmitting a non-access stratum protocol data unit comprising a register request to register with the second core network based at least in part on determining that the UE is unregistered with the second core network; and establishing a protocol data unit session with the second core network.

Aspect 7: The method of any of aspects 2 through 6, wherein determining whether the UE is registered with the second core network further comprises: identifying that the first core network is associated with a first public land mobile network and the second core network is associated with a second public land mobile network; and determining whether the UE is registered with the second public land mobile network.

Aspect 8: The method of any of aspects 2 through 7, further comprising:

identifying a system information block comprising information associated with the second slice, wherein identifying that the second slice is supported by the second core network is based at least in part on the system information block.

Aspect 9: The method of any of aspects 1 through 8, further comprising: determining that the UE is connected with a first distributed unit, the first distributed unit serving the first slice and a second distributed unit serving the second slice, wherein the UE transmits the control message to the first distributed unit and receives the reconfiguration message from the first distributed unit.

Aspect 10: The method of aspect 9, wherein determining that the UE is to further communicate with the second slice further comprises: determining an arrival of application data associated with the second slice; and determining that the second slice is unsupported by the first distributed unit and is supported by the second distributed unit.

Aspect 11: The method of aspect 10, further comprising: determining that a radio link quality between the UE and the second distributed unit meets a threshold.

Aspect 12: The method of any of aspects 9 through 11, further comprising: transmitting a reconfiguration complete message to the second distributed unit in response to receiving the reconfiguration message.

Aspect 13: The method of any of aspects 1 through 12, further comprising: determining that the UE is connected to a radio access network node, the radio access network node serving the first slice and the second slice, wherein the UE transmits the control message to the radio access network node and receives the reconfiguration message from the radio access network node.

Aspect 14: The method of aspect 13, wherein determining that the UE is to further communicate with the second slice further comprises: determining an arrival of application data associated with the second slice; and determining that the second slice is supported by the radio access network node.

Aspect 15: The method of any of aspects 13 through 14, further comprising: transmitting a reconfiguration complete message to the radio access network node in response to receiving the reconfiguration message.

Aspect 16: The method of any of aspects 1 through 15, wherein communicating with the second slice of the network further comprises: communicating with the second slice and the first slice concurrently based at least in part on a configuration of the first slice and the configuration of the second slice supporting concurrent usage.

Aspect 17: The method of any of aspects 1 through 16, wherein receiving the reconfiguration message further comprises: receiving the reconfiguration message comprising an indication to suspend configurations with the first slice based at least in part on a configuration of the first slice.

Aspect 18: The method of any of aspects 1 through 17, further comprising: receiving a second reconfiguration message comprising an indication for the UE to release configurations associated with the second slice and to resume communications with the first slice.

Aspect 19: The method of aspect 18, further comprising: releasing access stratum context and non-access stratum context associated with the second slice; and resuming access stratum context and non-access stratum context associated with the first slice based at least in part on the second reconfiguration message.

Aspect 20: The method of any of aspects 1 through 19, wherein the first slice and the second slice are supported by a single Packet Data Convergence Protocol unit or by separate Packet Data Convergence Protocol units.

Aspect 21: The method of any of aspects 1 through 20, wherein the first slice and the second slice are supported by a single dedicated radio bearer or by separate dedicated radio bearers. The two slices identified by slice indication or core network indication

Aspect 22: The method of aspect 21, further comprising: receiving an indication that the first slice is associated with a first core network, a first non-access stratum, or both and that the second slice is associated with a second core network, a second non-access stratum, or both based at least in part on the first slice and the second slice being supported by the single dedicated radio bearer.

Aspect 23: The method of any of aspects 1 through 22, wherein the first slice and the second slice are supported by a single signaling radio bearer or by separate signaling radio bearers. The two NAS entities identified by NAS entity indication or slice indication.

Aspect 24: The method of any of aspects 1 through 23, wherein the first slice is associated with a first non-access stratum and the second slice is associated with a second non-access stratum, the first control entity is a radio resource control entity that carries the first non-access stratum and the second non-access stratum.

Aspect 25: The method of any of aspects 1 through 24, wherein the first control entity is a first RRC entity, the control message is an RRC message, and the reconfiguration message is an RRC reconfiguration message.

Aspect 26: A method for wireless communications at a UE, comprising: identifying that the UE is in communication with a first slice of a first network via a first control entity at the UE; determining that the UE is to further communicate with a second slice of a second network via a second control entity at the UE; verifying that the second slice is supported by the second network; and registering with the second network based at least in part on the second slice being supported by the second network.

Aspect 27: The method of aspect 26, further comprising: receiving, via a system information block, supported slice information for the second network, wherein the verifying is based at least in part on the supported slice information.

Aspect 28: The method of any of aspects 26 through 27, wherein the first network and the second network are public land mobile networks (PLMNs).

Aspect 29: A method for wireless communications at a wireless device, comprising: identifying that a UE is in communication with a first slice of a network; determining that the UE is to further communicate with a second slice of the network; receiving a control message associated with a first control entity, the control message including a request pertaining to communications with the second slice; and transmitting, in response to the control message and at the first control entity, a reconfiguration message indicating a configuration for using the second slice.

Aspect 30: The method of aspect 29, wherein the first slice is supported by a first core network and the second slice is supported by a second core network, the method further comprises: selecting the second core network based at least in part on the control message; and relaying the control message to the second core network.

Aspect 31: The method of any of aspects 29 through 30, further comprising: receiving a UE context message and a non-access stratum protocol data unit associated with a second core network, wherein the non-access stratum protocol data unit comprises a service accept message or a protocol data unit session establishment accept message based at least in part on the control message from the UE.

Aspect 32: The method of aspect 31, further comprising: establishing a signaling radio bearer for the non-access stratum protocol data unit associated with the second core network.

Aspect 33: The method of any of aspects 31 through 32, further comprising: determining a reconfiguration of an existing signaling radio bearer for the non-access stratum protocol data unit associated with the second core network.

Aspect 34: The method of any of aspects 31 through 33, further comprising: establishing a dedicated radio bearer for the non-access stratum protocol data unit associated with the second core network.

Aspect 35: The method of any of aspects 29 through 34, further comprising: determining to suspend configurations associated with the first slice based at least in part on a configuration of the first slice.

Aspect 36: The method of aspect 35, wherein transmitting the reconfiguration message further comprises: transmitting the reconfiguration message comprising an indication to release configurations associated with the first slice.

Aspect 37: The method of any of aspects 29 through 36, further comprising: identifying an absence of data associated with the second slice while a release timer is running; and determining to resume communications with the first slice based at least in part on the absence of data.

Aspect 38: The method of aspect 37, further comprising: transmitting, to one or more other wireless devices, a UE context message comprising an indication to resume communications associated with the first slice; and transmitting a second reconfiguration message indicating the UE to release context associated with the second slice and to resume context associated with the first slice.

Aspect 39: The method of any of aspects 29 through 38, wherein the wireless device comprises a centralized unit and a distributed unit or comprises a radio access network node.

Aspect 40: The method of any of aspects 29 through 39, wherein the first slice and the second slice are supported by a single Packet Data Convergence Protocol unit or by separate Packet Data Convergence Protocol units.

Aspect 41: The method of any of aspects 29 through 40, wherein the first slice and the second slice are supported by a single dedicated radio bearer or by separate dedicated radio bearers. The two slices identified by slice indication or core network indication.

Aspect 42: The method of aspect 41, further comprising: transmitting an indication that the first slice is associated with a first core network, a first non-access stratum, or both and that the second slice is associated with a second core network, a second non-access stratum, or both based at least in part on the first slice and the second slice being supported by the single dedicated radio bearer.

Aspect 43: The method of any of aspects 29 through 42, wherein the first slice and the second slice are supported by a single signaling radio bearer or by separate signaling radio bearers. The two slices identified by slice indication or core network indication. The two NAS entities identified by NAS entity indication or slice indication.

Aspect 44: The method of any of aspects 29 through 42, wherein the first control entity is a first RRC entity, the control message is an RRC message, and the reconfiguration message is an RRC reconfiguration message.

Aspect 45: An apparatus for wireless communications, comprising a processor; memory coupled with the processor; and instructions stored in the memory and executable by the processor to cause the apparatus to perform a method of any of aspects 1 through 25.

Aspect 46: An apparatus for wireless communications, comprising at least one means for performing a method of any of aspects 1 through 25.

Aspect 47: A non-transitory computer-readable medium storing code for wireless communications at a UE, the code comprising instructions executable by a processor to perform a method of any of aspects 1 through 25.

Aspect 48: An apparatus for wireless communications, comprising a processor; memory coupled with the processor; and instructions stored in the memory and executable by the processor to cause the apparatus to perform a method of any of aspects 26 through 28.

Aspect 49: An apparatus for wireless communications, comprising at least one means for performing a method of any of aspects 26 through 28.

Aspect 50: A non-transitory computer-readable medium storing code for wireless communications at a UE, the code comprising instructions executable by a processor to perform a method of any of aspects 26 through 28.

Aspect 51: An apparatus for wireless communications, comprising a processor; memory coupled with the processor; and instructions stored in the memory and executable by the processor to cause the apparatus to perform a method of any of aspects 29 through 44.

Aspect 52: An apparatus for wireless communications, comprising at least one means for performing a method of any of aspects 29 through 44.

Aspect 53: A non-transitory computer-readable medium storing code for wireless communications, the code comprising instructions executable by a processor to perform a method of any of aspects 29 through 44.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
identifying that the UE is in communication with a first slice of a network via a first control entity at the UE;
determining that the UE is to further communicate with a second slice of the network;
transmitting a control message associated with the first control entity, the control message including a request pertaining to communications with the second slice;
receiving, in response to the control message and at the first control entity, a reconfiguration message indicating a configuration for using the second slice; and
communicating with the second slice of the network based at least in part on the configuration.

2. The method of claim 1, further comprising:
identifying that the first slice is associated with a first core network and the second slice is supported by a second core network; and
determining whether the UE is registered with the second core network based at least in part on determining that the UE is to further communicate with the second slice.

3. The method of claim 2, wherein transmitting the control message further comprises:
transmitting a non-access stratum protocol data unit comprising information associated with the second slice based at least in part on determining that the UE is registered with the second core network.

4. The method of claim 3, wherein transmitting the control message further comprises:
transmitting the non-access stratum protocol data unit comprising a service request to activate a protocol data unit session for the second slice.

5. The method of claim 3, wherein transmitting the control message further comprises:
determining whether there is an existing protocol data unit session for the second slice; and
transmitting the non-access stratum protocol data unit comprising a protocol data unit session establishment request to establish a protocol data unit session based at least in part on the determination of whether there is the existing protocol data unit session.

6. The method of claim 2, wherein transmitting the control message further comprises:
transmitting a non-access stratum protocol data unit comprising a register request to register with the second core network based at least in part on determining that the UE is unregistered with the second core network; and
establishing a protocol data unit session with the second core network.

7. The method of claim 2, wherein determining whether the UE is registered with the second core network further comprises:
identifying that the first core network is associated with a first public land mobile network and the second core network is associated with a second public land mobile network; and
determining whether the UE is registered with the second public land mobile network.

8. The method of claim 2, further comprising:
identifying a system information block comprising information associated with the second slice, wherein identifying that the second slice is supported by the second core network is based at least in part on the system information block.

9. The method of claim 1, further comprising:
determining that the UE is connected with a first distributed unit, the first distributed unit serving the first slice and a second distributed unit serving the second slice, wherein the UE transmits the control message to the first distributed unit and receives the reconfiguration message from the first distributed unit.

10. The method of claim 9, wherein determining that the UE is to further communicate with the second slice further comprises:
determining an arrival of application data associated with the second slice; and
determining that the second slice is unsupported by the first distributed unit and is supported by the second distributed unit.

11. The method of claim 10, further comprising:
determining that a radio link quality between the UE and the second distributed unit meets a threshold.

12. The method of claim 9, further comprising:
transmitting a reconfiguration complete message to the second distributed unit in response to receiving the reconfiguration message.

13. The method of claim 1, further comprising:
determining that the UE is connected to a radio access network node, the radio access network node serving the first slice and the second slice, wherein the UE transmits the control message to the radio access network node and receives the reconfiguration message from the radio access network node.

14. The method of claim 13, wherein determining that the UE is to further communicate with the second slice further comprises:
determining an arrival of application data associated with the second slice; and
determining that the second slice is supported by the radio access network node.

15. The method of claim 13, further comprising:
transmitting a reconfiguration complete message to the radio access network node in response to receiving the reconfiguration message.

16. The method of claim 1, wherein communicating with the second slice of the network further comprises:
communicating with the second slice and the first slice concurrently based at least in part on a configuration of the first slice and the configuration of the second slice supporting concurrent usage.

17. The method of claim 1, wherein receiving the reconfiguration message further comprises:
receiving the reconfiguration message comprising an indication to suspend configurations with the first slice based at least in part on a configuration of the first slice.

18. The method of claim 1, further comprising:
receiving a second reconfiguration message comprising an indication for the UE to release configurations associated with the second slice and to resume communications with the first slice.

19. The method of claim 18, further comprising:
releasing access stratum context and non-access stratum context associated with the second slice; and
resuming access stratum context and non-access stratum context associated with the first slice based at least in part on the second reconfiguration message.

20. The method of claim 1, wherein the first slice and the second slice are supported by a single Packet Data Convergence Protocol unit or by separate Packet Data Convergence Protocol units.

21. An apparatus for wireless communications, comprising:
a processor;
memory coupled with the processor; and
instructions stored in the memory and executable by the processor to cause the apparatus to:
identify that a user equipment (UE) is in communication with a first slice of a network via a first control entity at the UE;
determine that the UE is to further communicate with a second slice of the network;
transmit a control message associated with the first control entity, the control message including a request pertaining to communications with the second slice;
receive, in response to the control message and at the first control entity, a reconfiguration message indicating a configuration for using the second slice; and
communicate with the second slice of the network based at least in part on the configuration.

22. The apparatus of claim 21, wherein the instructions are further executable by the processor to cause the apparatus to:
identify that the first slice is associated with a first core network and the second slice is supported by a second core network; and
determine whether the UE is registered with the second core network based at least in part on determining that the UE is to further communicate with the second slice.

23. The apparatus of claim 22, wherein the instructions to transmit the control message are further executable by the processor to cause the apparatus to:
transmit a non-access stratum protocol data unit comprising information associated with the second slice based at least in part on determining that the UE is registered with the second core network.

24. The apparatus of claim 22, wherein the instructions are further executable by the processor to cause the apparatus to:
identify a system information block comprising information associated with the second slice, wherein identifying that the second slice is supported by the second core network is based at least in part on the system information block.

25. The apparatus of claim 21, wherein the instructions to communicate with the second slice of the network are further executable by the processor to cause the apparatus to:
communicate with the second slice and the first slice concurrently based at least in part on a configuration of the first slice and the configuration of the second slice supporting concurrent usage.

26. The apparatus of claim 21, wherein the instructions to receive the reconfiguration message are further executable by the processor to cause the apparatus to:
receive the reconfiguration message comprising an indication to suspend configurations with the first slice based at least in part on a configuration of the first slice.

27. The apparatus of claim 21, wherein the instructions are further executable by the processor to cause the apparatus to:
receive a second reconfiguration message comprising an indication for the UE to release configurations associated with the second slice and to resume communications with the first slice.

28. The apparatus of claim 21, wherein:
the first slice is associated with a first non-access stratum and the second slice is associated with a second non-access stratum,
the first control entity is a radio resource control entity that carries the first non-access stratum and the second non-access stratum.

29. An apparatus for wireless communications, comprising:
means for identifying that a user equipment (UE) is in communication with a first slice of a network via a first control entity at the UE;
means for determining that the UE is to further communicate with a second slice of the network;
means for transmitting a control message associated with the first control entity, the control message including a request pertaining to communications with the second slice;
means for receiving, in response to the control message and at the first control entity, a reconfiguration message indicating a configuration for using the second slice; and
means for communicating with the second slice of the network based at least in part on the configuration.

30. A non-transitory computer-readable medium storing code for wireless communications, the code comprising instructions executable by a processor to:
identify that a user equipment (UE) is in communication with a first slice of a network via a first control entity at the UE;
determine that the UE is to further communicate with a second slice of the network;
transmit a control message associated with the first control entity, the control message including a request pertaining to communications with the second slice;
receive, in response to the control message and at the first control entity, a reconfiguration message indicating a configuration for using the second slice; and
communicate with the second slice of the network based at least in part on the configuration.
